(19) United States
(12) Patent Application Publication
(10) Pub. No.: US 2025/0301120 A1
(43) Pub. Date: Sep. 25, 2025

(54) SYSTEM AND METHOD FOR DYNAMIC TESTING OF A MACHINE VISION SYSTEM

(71) Applicant: COGNEX CORPORATION, Natick, MA (US)

(72) Inventors: Caitlin WURZ, Natick, MA (US); Humberto Andres Leon LIU, III, Natick, MA (US); Patrick BRODEUR, Natick, MA (US); Georges GAUTHIER, Cambridge, MA (US); Kyle SPOSATO, Natick, MA (US); Michael CORBETT, Natick, MA (US); Saul SANZ RODRIGUEZ, Aachen (DE); Jens RUETTEN, Aachen (DE)

(21) Appl. No.: 18/864,223

(22) PCT Filed: May 9, 2023
(86) PCT No.: PCT/US2023/066779

§ 371 Date: Nov. 8, 2024

Related U.S. Application Data
(60) Provisional application No. 63/339,862, filed on May 9, 2022.

(51) Int. Cl. H04N 17/00

(52) U.S. Cl. CPC H04N 17/002

(57) ABSTRACT

A method for dynamic testing of a machine vision system includes receiving a set of testing parameters and a selection of a tunnel system. The machine vision system can include the tunnel system and the tunnel system can include a conveyor and at least one imaging device. The method can further include validating the testing parameters and controlling the at least one imaging device to acquire a set of image data of a testing target positioned at a predetermined justification on the conveyor. The testing target can include a plurality of target symbols. The method can further include determining a test result by analyzing the set of image data to determine if the at least one imaging device reads a target symbol associated with the at least one imaging device and generating a report including the test result.

### CROSS-REFERENCE TO RELATED APPLICATIONS

This application is based on, claims priority to, and incorporates herein by reference in its entirety Ser. No. 63/339,862 filed May 9, 2022 and entitled “System and Method for Dynamic Testing of a Machine Vision System.”

### STATEMENT REGARDING FEDERALLY SPONSORED RESEARCH

N/A

### BACKGROUND

The present technology relates to imaging systems, including machine vision systems that are configured to acquire and analyze images of objects or symbols (e.g., barcodes).

Machine vision systems are generally configured for use in capturing images of objects or symbols and analyzing the images to identify the objects or decode the symbols. Accordingly, machine vision systems generally include one or more devices for image acquisition and image processing. In conventional applications, these devices can be used to acquire images, or to analyze acquired images, such as for the purpose of decoding imaged symbols such as barcodes or text. In some contexts, machine vision and other imaging systems can be used to acquire images of objects that may be larger than a field of view (FOV) for a corresponding imaging device and/or that may be moving relative to an imaging device.

### SUMMARY

In accordance with an embodiment of the technology, a method for dynamic testing of a machine vision system includes receiving a set of testing parameters and a selection of a tunnel system. The machine vision system can include the tunnel system and the tunnel system can include a conveyor and at least one imaging device. The method can further include validating the testing parameters and controlling the at least one imaging device to acquire a set of image data of a testing target positioned at a predetermined justification on the conveyor. The testing target can include a plurality of target symbols. The method can further include determining a test result by analyzing the set of image data to determine if the at least one imaging device reads a target symbol associated with the at least one imaging device and generating a report including the test result.

In some embodiments, the method further includes displaying the test result using a display. In some embodiments, the set of image data of the testing target can include image data of the testing target positioned at the predetermined justification corresponding to a right side of the conveyor. In some embodiments, the set of image data of the testing target can include image data of the testing target positioned at the predetermined justification corresponding to a left side of the conveyor. In some embodiments, the testing parameters can include one or more of a height of the testing target or a test type indicating a size of the plurality of target symbols of the testing target. In some embodiments, the height of the testing target is a pre-specified maximum height supported by the tunnel system. In some embodiments, the method further includes before acquiring the set of image data, storing a set of existing customer system settings for the at least one imaging device. In some embodiments, the method can further include after storing the set of existing customer system settings for the at least one imaging device, reconfiguring the at least one imaging device based on the testing parameters. In some embodiments, the method further includes, after determining the test result, restoring the at least one imaging device to the existing customer system settings. In some embodiments, the at least one imaging device includes a plurality of imaging devices and the plurality of imaging devices can be divided into a plurality of banks. In some embodiments, determining a test result can further include analyzing the set of image data to determine if at least one imaging device in the bank reads a target symbol associated with the bank. In some embodiments, the at least one imaging device includes one imaging device. In some embodiments, the method further includes determining if the at least one imaging device correctly received motion data based on the set of image data.

In accordance with another embodiment, a system for dynamic testing of a machine vision system includes an input and at least one processor device. The machine vision system can include a tunnel system and the tunnel system can include a conveyor and at least one imaging device. The input can be configured to receive a set of testing parameters and a selection of a tunnel system The at least one processor device can be coupled to the input and can be configured to validate the testing parameters and control the at least one imaging device to acquire a set of image data of a testing target positioned at a predetermined justification on the conveyor. The testing target can include a plurality of target symbols. The processor device can be further configured to determine a test result by analyzing the set of image data to determine if the at least one imaging device reads a target symbol associated with the at least one imaging device and to generate a report including the test result.

In some embodiments, the system further includes a display coupled to the at least one processor device and configured to display the test result. In some embodiments, the set of image data of the testing target can include image data of the testing target positioned at the predetermined justification corresponding to a right side of the conveyor. In some embodiments, the set of image data of the testing target can include image data of the testing target positioned at the predetermined justification corresponding to a left side of the conveyor. In some embodiments, the at least one imaging device comprises a plurality of imaging devices and the plurality of imaging devices can be divided into a plurality of banks. In some embodiments, determining a test result further includes analyzing the set of image data to determine if at least one imaging device in the bank reads a target symbol associated with the bank. In some embodiments, the at least one imaging device comprises one imaging device. In some embodiments, the at least one processor device is further configured to determine if the at least one imaging device correctly received motion data based on the set of image data.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A shows an example of a system for capturing multiple images of each side of an object in accordance with an embodiment of the technology;

FIG. 1B shows an example of a system for capturing multiple images of each side of an object in accordance with an embodiment of the technology;

FIG. 2 shows another example of a system for capturing multiple images of each side of an object in accordance with an embodiment of the technology;

FIG. 3 shows another example system for capturing multiple images of each side of an object in accordance with an embodiment of the technology;

FIG. 4 shows a system for dynamic testing of a machine vision system accordance with an embodiment of the technology;

FIG. 5 shows an example of a server in the system shown in FIG. 4 in accordance with an embodiment of the technology;

FIG. 6 illustrates a method for dynamic testing of a machine vision system in accordance with an embodiment of the technology;

FIGS. 7A and 7B illustrate an example setup page user interface in accordance with an embodiment of the technology;

FIGS. 8A and 8B illustrate an example device preparation user interface in accordance with an embodiment of the technology;

FIGS. 9A-9C illustrate an example encoder check user interface in accordance with an embodiment of the technology;

FIGS. 10A-10C illustrate an example right justify test user interface in accordance with an embodiment of the technology;

FIGS. 11A-11C illustrate an example left justify test user interface in accordance with an embodiment of the technology; and

FIGS. 12A and 12B illustrate an example results summary user interface in accordance with an embodiment of the technology;

FIG. 13 illustrates an example justify test user interface in accordance with an embodiment of the technology.

### DETAILED DESCRIPTION

Machine vision systems can include one or more imaging devices. For example, in some embodiments, a machine vision system may be implemented in a tunnel arrangement (or system) which can include a structure on which each of the imaging devices can be positioned at an angle relative to a conveyor resulting in an angled FOV. As used herein, “machine vision tunnel” (or simply “tunnel” or “tunnel system”) may refer to a system that includes and supports one or more imaging devices to acquire image data relative to a common scene. In some embodiments, the common scene can include a relatively small area such as, for example, a tabletop or a discrete section of a conveyor. In some embodiments, within a given tunnel system there may be overlap between the FOVs of imaging devices, no overlap between FOVs of imaging devices, or a combination thereof (e.g., overlap between certain sets of imaging devices but not between others, collective overlap of multiple imaging devices to cover an entire scene, etc.).

Deployment of a machine vision system. e.g., a tunnel system, at a customer site can involve a number of steps including installation, commissioning, field calibration and testing. Customized machine vision systems can require a complicated and lengthy installation and setup and require a large number of resources. It would be advantageous to provide systems and applications that can simplify and streamline deployment of a machine vision system. For example, modular hardware elements (e.g., prebuilt modules) that can be configured to implement a plurality of system configurations and specifications can reduce installation time. The present disclosure describes systems and methods configured for simplifying the deployment process including a dynamic testing process for an installed machine vision system. In some embodiments, the systems and methods for dynamic testing can include integrated hardware and software elements including applications that can automate one or more portions of the dynamic testing process. Advantageously, the disclosed dynamic testing system can provide a standardized testing interface that can provide repeatability from system to system and customer to customer. The disclosed system and method for dynamic testing can also reduce the time (and therefore the amount of required downtime) and resources necessary to install a machine vision system and therefore, improve efficiency of deployment of the machine vision system. In addition, the disclosed system and method for dynamic testing can reduce the number of trained personnel required to support and maintain an installed machine vision system. While the following description refers to a tunnel system or arrangement, it should be understood that the systems and methods for dynamic testing described herein may be applied to other types of machine vision system arrangements.

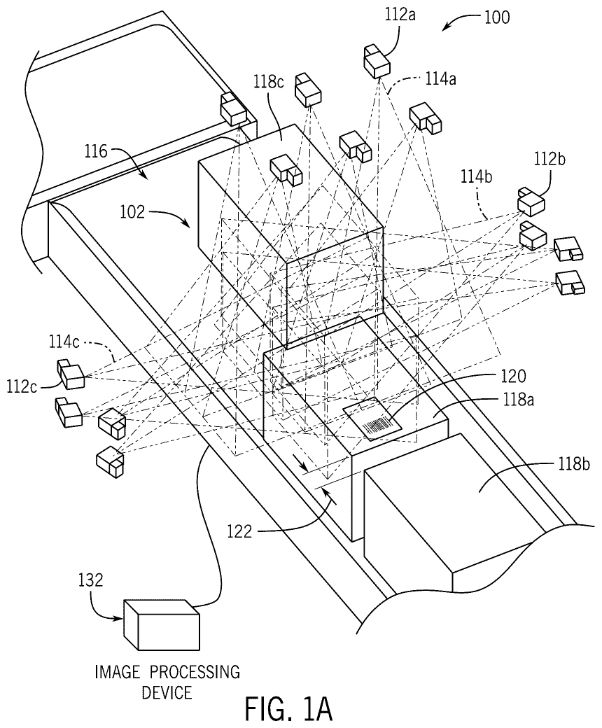

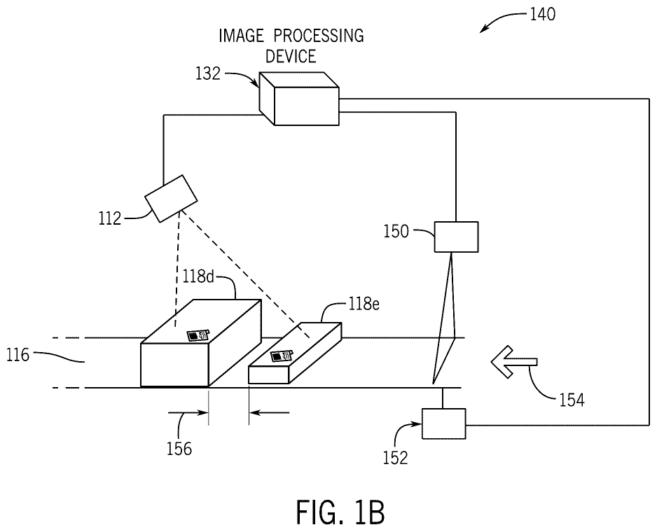

FIG. 1A shows an example of a system 100 for capturing multiple images of each side of an object in accordance with an embodiment of the technology. In some embodiments, system 100 can be configured to evaluate symbols (e.g., barcodes, two-dimensional (2D) codes, fiducials, hazmat, machine readable code, alpha-numeric codes, and other labels) on objects (e.g., objects 118a, 118b) moving through a tunnel 102, such as a symbol 120 on object 118a. In some embodiments, symbol 120 is a flat barcode on a top surface of object 118a, and objects 118a and 118b are roughly cuboid boxes. Additionally or alternatively, in some embodiments, any suitable geometries are possible for an object to be imaged, and any variety of symbols and symbol locations can be imaged and evaluated, including non-direct part mark (DPM) symbols and DPM symbols located on a top or any other side of an object. Alternatively, or in addition, in some embodiments, a non-symbol recognition approach may be implemented. As one example, some implementations can include a vision-based recognition of non-symbol based features, such as, e.g., one or more edges of the object.

In FIG. 1A, objects 118a and 118b are disposed on a conveyor 116 that is configured to move objects 118a and 118b in a direction of travel (e.g., horizontally left-to-right) through tunnel 102 at a relatively predictable and continuous rate, or at a variable rate measured by a device, such as an encoder or other motion measurement device. Additionally or alternatively, objects can be moved through tunnel 102 in other ways (e.g., with non-linear movement). In some embodiments, conveyor 116 can include a conveyor belt. In some embodiments, conveyor 116 can consist of other types of transport systems.

In some embodiments, system 100 can include one or more imaging devices 112 and an image processing device 132. For example, system 100 can include multiple imaging devices in a tunnel arrangement (e.g., implementing a portion of tunnel 102), representatively shown via imaging devices 112a, 112b, and 112c, each with a field-of-view (“FOV”), representatively shown via FOV 114a, 114b, 114c, that includes part of the conveyor 116. In some embodiments, each imaging device 112 can be positioned at an angle relative to the conveyor top or side (e.g., at an angle relative to a normal direction of symbols on the sides of the objects 118a and 118b or relative to the direction of travel), resulting in an angled FOV. Similarly, some of the FOVs can overlap with other FOVs (e.g., FOV 114a and FOV 114b). In such embodiments, system 100 can be configured to capture one or more images of multiple sides of objects 118a and/or 118b as the objects are moved by conveyor 116. In some embodiments, the captured images can be used to identify symbols on each object (e.g., a symbol 120) which can be subsequently decoded or analyzed (as appropriate). In some embodiments, a gap in conveyor 116 (not shown) can facilitate imaging of a bottom side of an object (e.g., as described in U.S. Patent Application Publication No. 2019/0333259, filed on Apr. 25, 2018, which is hereby incorporated by reference herein in its entirety) using an imaging device or array of imaging devices (not shown), disposed below conveyor 116). In some embodiments, the captured images from a bottom side of the object may also be used to identify symbols on the object which can be subsequently decoded (as appropriate).

Note that although two arrays of three imaging devices 112 are shown imaging a top of objects 118a and 118b, and four arrays of two imaging devices 112 are shown imaging sides of objects 118a and 118b, this is merely an example, and any suitable number of imaging devices can be used to capture images of various sides of objects. For example, each array can include four or more imaging devices. In some cases, the system 100 may include a smaller number of imaging devices 112 than shown in FIG. 1A or a greater number of imaging devices 112. For example, as discussed above a tunnel system may include only one imaging device 112. In some cases, the single imaging device 112 may be positioned to image a top of objects 118a and 118b, to image a side of objects 118a and 118b, or may be positioned to image a bottom of objects 118a and 118b. In another example, various combinations of two or more imaging devices 112 (e.g., various combinations of imaging devices 112a, 112b and 112c) may be included in the system 100. In some cases, one imaging device 112a may be positioned to image a top of objects 118a and 118b and one imaging device 112b may be positioned to image a side of objects 118a and 118b. In other cases, one imaging device 112a may be positioned to image a top of objects 118a and 118b and one imaging device 112c may be positioned to image a side of objects 118a and 118b.

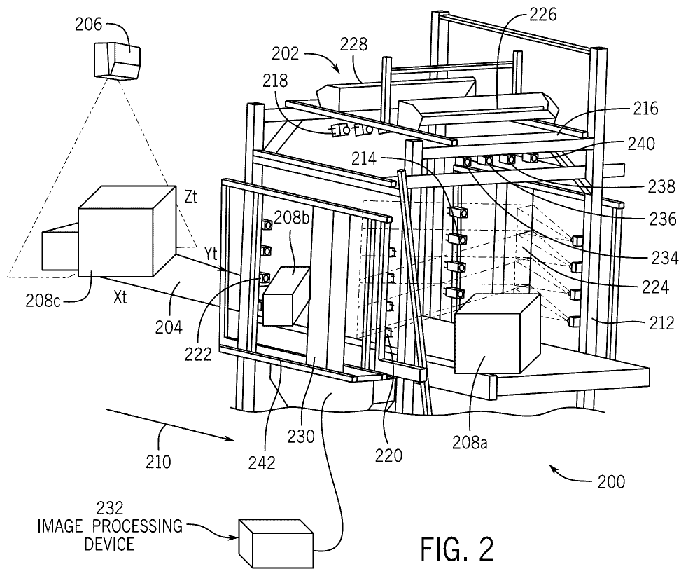

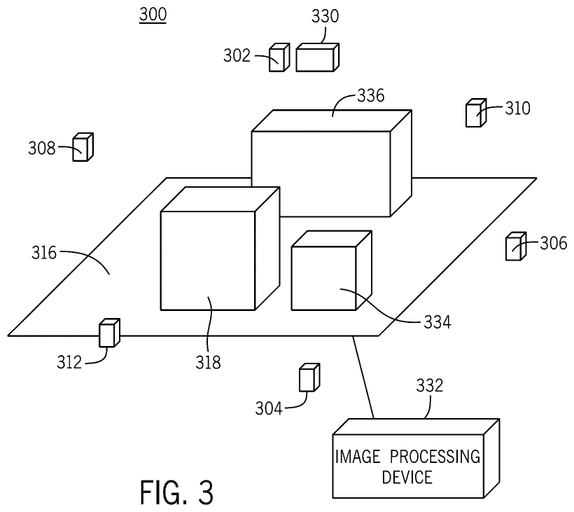

Although imaging devices 112 are generally shown imaging objects 118a and 118b without mirrors to redirect a FOV, this is merely an example, and one or more fixed and/or steerable mirrors can be used to redirect a FOV of one or more of the imaging devices as described below with respect to FIGS. 2 and 3, which may facilitate a reduced vertical or lateral distance between imaging devices and objects in tunnel 102. For example, imaging device 112a can be disposed with an optical axis parallel to conveyor 116, and one or more mirrors can be disposed above tunnel 102 to redirect a FOV from imaging devices 112a toward a front and top of objects in tunnel 102.

In some embodiments, imaging devices 112 can be implemented using any suitable type of imaging device(s). For example, imaging devices 112 can be implemented using 2D imaging devices (e.g., 2D cameras), such as area scan cameras and/or line scan cameras. In some embodiments, imaging device 112 can be an integrated system that includes a lens assembly and an imager, such as a CCD or CMOS sensor. In some embodiments, imaging devices 112 may each include one or more image sensors, at least one lens arrangement, and at least one control device (e.g., a processor device) configured to execute computational operations relative to the image sensor. Each of the imaging devices 112a, 112b, or 112c can selectively acquire image data from different fields of view (FOVs), regions of interest (“ROIs”), or a combination thereof. In some embodiments, system 100 can be utilized to acquire multiple images of each side of an object where one or more images may include more than one object. Object 118 may be associated with one or more symbols, such as a barcode, a QR code, etc. In some embodiments, system 100 can be configured to facilitate imaging of the bottom side of an object supported by conveyor 116 (e.g., the side of object 118a resting on conveyor 116). For example, conveyor 116 may be implemented with a gap, such as a gap between sections of the conveyor 116 (as also discussed above).

In some embodiments, a gap 122 is provided between objects 118a, 118b. In different implementations, gaps between objects can range in size. In some implementations, gaps between objects can be substantially the same between all sets of objects in a system, or can exhibit a fixed minimum size for all sets of objects in a system. In some embodiments, smaller gap sizes may be used to maximize system throughput.

In some embodiments, system 100 can include a dimensioning system (not shown), sometime referred to herein as a dimensioner, that can measure dimensions of objects moving toward tunnel 102 on conveyor 116. Additionally, system 100 can include devices (e.g., an encoder or other motion measurement device, not shown) to track the physical movement of objects (e.g., objects 118a, 118b) moving through the tunnel 102 on the conveyor 116. FIG. 1B shows an example of a system for capturing multiple images of each side of an object in accordance with an embodiment of the technology. FIG. 1B shows a simplified diagram of a system 140 to illustrate an example arrangement of a dimensioner and a motion measurement device (e.g., an encoder) with respect to a tunnel. As mentioned above, the system 140 may include a dimensioner 150 and a motion measurement device 152. In the illustrated example, a conveyor 116 is configured to move objects 118d, 118e along the direction of travel (e.g., the direction indicated by arrow 154) past a dimensioner 150 before the objects 118d, 118e are imaged by one or more imaging devices 112. In the illustrated embodiment, a gap 156 is provided between objects 118d and 118e and an image processing device 132 may be in communication with the one or more imaging devices 112, dimensioner 150 and motion measurement device 152. Dimensioner 150 can be configured to determine dimensions and/or a location of an object supported by support structure 116 (e.g., object 118d or 118e) at a certain point in time. For example, dimensioner 150 can be configured to determine a distance from dimensioner 150 to a top surface of the object, and can be configured to determine a size and/or orientation of a surface facing dimensioner 150. In some embodiments, dimensioner 150 can be implemented using various technologies. For example, dimensioner 150 can be implemented using a 3D camera (e.g., a structured light 3D camera, a continuous time of flight 3D camera, etc.). As another example, dimensioner 150 can be implemented using a laser scanning system (e.g., a LiDAR system). In a particular example, dimensioner 150 can be implemented using a 3D-A1000 system available from Cognex Corporation. In some embodiments, the dimensioning system or dimensioner 150 (e.g., a time-of-flight sensor or computed from stereo) may be implemented in a single device or enclosure with an imaging device (e.g., a 2D camera) and, in in some embodiments, a processor (e.g., that may be utilized as the image processing device) may also be implemented in the device with the dimensioner and imaging device.

In some embodiments, dimensioner 150 can determine 3D coordinates of each corner of the object in a coordinate space defined with reference to one or more portions of system 140. For example, dimensioner 150 can determine 3D coordinates of each of eight corners of an object that is at least roughly cuboid in shape within a Cartesian coordinate space defined with an origin at dimensioner 150. As another example, dimensioner 150 can determine 3D coordinates of each of eight corners of an object that is at least roughly cuboid in shape within a Cartesian coordinate space defined with an origin at the dimensioner 150. As another example, dimensioner 150 can determine 3D coordinates of each of eight corners of an object that is at least roughly cuboid in shape within a Cartesian coordinate space defined with respect to conveyor 116 (e.g., with an origin that originates at a center of conveyor 116).

In some embodiments, a motion measurement device 152 (e.g., an encoder) may be linked to the conveyor 116 and imaging devices 112 to provide electronic signals to the imaging devices 112 and/or image processing device 132 that indicate the amount of travel of the conveyor 116, and the objects 118d, 118e supported thereon, over a known amount of time. This may be useful, for example, in order to coordinate capture of images of particular objects (e.g., objects 118d, 118e), based on calculated locations of the object relative to a field of view of a relevant imaging device (e.g., imaging device(s) 112). In some embodiments, motion measurement device 152 may be configured to generate a pulse count (e.g., an encoder pulse count) that can be used to identify the position of conveyor 116 along the direction of travel (e.g., the direction of the arrow 154). For example, motion measurement device 152 may provide the pulse count to image processing device 132 for identifying and tracking the positions of objects (e.g., objects 118d, 118e) on conveyor 116. In some embodiments, the motion measurement device 152 can increment a pulse count (e.g., an encoder pulse count) each time conveyor 116 moves a predetermined distance (pulse count distance) in the direction of arrow 154. In some embodiments, an object's position can be determined based on an initial position, the change in the pulse count, and the pulse distance.

As mentioned above, a tunnel system can include and support one or more imaging devices to acquire image data relative to a common scene. In some embodiments, the tunnel system can include one imaging device, for example, in FIG. 1B in some embodiments, imaging device 112 may represent a single imaging device. While imaging device 112 is shown in a position at the top of the system 140 above the conveyor, in some cases, the imaging device 112 may be positioned on the side of the system 140 or may be positioned below the system 140 (e.g., below a gap in the conveyor 116).

In some embodiments, image processing device 132 (or a control device) can coordinate operations of various components of system 100 (or system 140). For example, image processing device 132 can cause a dimensioner (e.g., dimensioner 150 shown in FIG. 1B) to acquire dimensions of an object positioned on conveyor 116 and can cause imaging devices 112 to capture images of each side. In some embodiments, image processing device 132 can control detailed operations of each imaging device, for example, by providing trigger signals to cause the imaging device to capture images at particular times, etc. Alternatively, in some embodiments, another device (e.g., a processor included in each imaging device, a separate controller device, etc.) can control detailed operations of each imaging device. For example, image processing device 132 (and/or any other suitable device) can provide a trigger signal to each imaging device and/or dimensioner (e.g., dimensioner 150 shown in FIG. 1B), and a processor of each imaging device can be configured to implement a predesignated image acquisition sequence that spans a predetermined region of interest in response to the trigger. Note that system 100 can also include one or more light sources (not shown) to illuminate surfaces of an object, and operation of such light sources can also be coordinated by a central device (e.g., image processing device 132), and/or control can be decentralized (e.g., an imaging device can control operation of one or more light sources, a processor associated with one or more light sources can control operation of the light sources, etc.). For example, in some embodiments, system 100 can be configured to concurrently (e.g., at the same time or over a common time interval) acquire images of multiple sides of an object, including as part of a single trigger event. For example, each imaging device 112 can be configured to acquire a respective set of one or more images over a common time interval. Additionally or alternatively, in some embodiments, imaging devices 112 can be configured to acquire the images based on a single trigger event. For example, based on a sensor (e.g., a contact sensor, a presence sensor, an imaging device, etc.) determining that object 118 has passed into the FOV of the imaging devices 112, imaging devices 112 can concurrently acquire images of the respective sides of object 118.

As mentioned above, one or more fixed and/or steerable mirrors can be used to redirect a FOV of one or more of the imaging devices, which may facilitate a reduced vertical or lateral distance between imaging devices and objects in tunnel 102. FIG. 2 shows another example of a system for capturing multiple images of each side of an object in accordance with an embodiment of the technology. System 200 includes multiple banks of imaging devices 212, 214, 216, 218, 220, 222 and multiple mirrors 224, 226, 228, 230 in a tunnel arrangement 202. For example, the banks of imaging devices shown in FIG. 2 include a left trail bank 212, a left lead bank 214, a top trail bank 216, a top lead bank 218, a right trail bank 220 and a right lead bank 222. In the illustrated embodiment, each bank 212, 214, 216, 218, 220, 222 includes four imaging devices that are configured to capture images of one or more sides of an object (e.g., object 208a) and various FOVs of the one or more sides of the object. For example, top trail bank 216 and mirror 228 may be configured to capture images of the top and back surfaces of an object using imaging devices 234, 236, 238, and 240. In the illustrated embodiment, the banks of imaging devices 212, 214, 216, 218, 220, 222 and mirrors 224, 226, 228, 230 can be mechanically coupled to a support structure 242 above a conveyor 204. Note that although the illustrated mounting positions of the banks imaging devices 212, 214, 216, 218, 220, 222 relative to one another can be advantageous, in some embodiments, imaging devices for imaging different sides of an object can be reoriented relative to the illustrated positions in FIG. 2 (e.g., imaging devices can be offset, imaging devices can be placed at the corners, rather than the sides, etc.). Similarly, while there can be advantages associated with using four imaging devices per bank that are each configured to acquire image data from one or more sides of an object, in some embodiments, a different number or arrangement of imaging devices, a different arrangement of mirror (e.g., using steerable mirrors, using additional fixed mirrors, etc.) can be used to configure a particular imaging device to acquire images of multiple sides of an object. In some embodiments, an imaging device can be dedicated to acquiring images of multiple sides of an object including with overlapping acquisition areas relative to other imaging devices included in the same system.

In some embodiments, system 200 also includes a dimensioner 206 and an image processing device 232. As discussed above, multiple objects 208a, 208b and 208c may be supported in the conveyor 204 and travel through the tunnel 202 along a direction indicated by arrow 210. In some embodiments, each bank of imaging devices 212, 214, 216, 218, 220, 222 (and each imaging device in a bank) can generate a set of images depicting a FOV or various FOVs of a particular side or sides of an object supported by conveyor 204 (e.g., object 208a).

Note that although FIGS. 1A, 1B and 2 depict a dynamic support structure (e.g., conveyor 116, conveyor 204) that is moveable, in some embodiments, a stationary support structure may be used to support objects to be imaged by one or more imaging devices. In some embodiments (not shown), the objects to be imaged can be passed through the coverage area by an operator temporarily until the desired vision operations have been completed. FIG. 3 shows another example system for capturing multiple images of each side of an object in accordance with an embodiment of the technology. In some embodiments, system 300 can include multiple imaging devices 302, 304, 306, 308, 310, and 312, which can each include one or more image sensors, at least one lens arrangement, and at least one control device (e.g., a processor device) configured to execute computational operations relative to the image sensor. In some embodiments, imaging devices 302, 304, 306, 308, 310, and/or 312 can include and/or be associated with a steerable mirror (e.g., as described in U.S. application Ser. No. 17/071,636, filed on Oct. 13, 2020, which is hereby incorporated by reference herein in its entirety). Each of the imaging devices 302, 304, 306, 308, 310, and/or 312 can selectively acquire image data from different fields of view (FOVs), corresponding to different orientations of the associated steerable mirror(s). In some embodiments, system 300 can be utilized to acquire multiple images of each side of an object. While FIG. 3 illustrates multiple imaging devices 302, 304, 306, 308, 310, and 312, it should be understood that in some embodiments system 300 can include one imaging device or can include various combinations of two or more imaging devices.

In some embodiments, system 300 can be used to acquire images of multiple objects presented for image acquisition. For example, system 300 can include a support structure that supports each of the imaging devices 302, 304, 306, 308, 310, 312 and a platform 316 configured to support one or more objects 318, 334, 336 to be imaged (note that each object 318, 334, 336 may be associated with one or more symbols, such as a barcode, a QR code, etc.). For example, a transport system (not shown), including one or more robot arms (e.g., a robot bin picker), may be used to position multiple objects (e.g., in a bin or other container) on platform 316. In some embodiments, the support structure can be configured as a caged support structure. However, this is merely an example, and the support structure can be implemented in various configurations. In some embodiments, support platform 316 can be configured to facilitate imaging of the bottom side of one or more objects supported by the support platform 316 (e.g., the side of an object (e.g., object 318, 334, or 336) resting on platform 316). For example, support structure 316 can be implemented using a transparent platform, a mesh or grid platform, an open center platform, or any other suitable configuration. Other than the presence of support structure 316, acquisition of images of the bottom side can be substantially similar to acquisition of other sides of the object. As a further example, a transport system (not shown), including one or more robot arms (e.g., a robot bin picker), may be used to position multiple objects (e.g., in a bin or other container) on the support platform 316.

In some embodiments, imaging devices 302, 304, 306, 308, 310, and/or 312 can be oriented such that a FOV of the imaging device can be used to acquire images of a particular side of an object resting on support platform 316, such that each side of an object (e.g., object 318) placed on and supported by support platform 316 can be imaged by imaging devices 302, 304, 306, 308, 310, and/or 312. For example, imaging device 302 can be mechanically coupled to the support structure above support platform 316, and can be oriented toward an upper surface of support platform 316, imaging device 304 can be mechanically coupled to the support structure below support platform 316, and imaging devices 306, 308, 310, and/or 312 can each be mechanically coupled to a side of the support structure, such that a FOV of each of imaging devices 306, 308, 310, and/or 312 faces a lateral side of support platform 316.

In some embodiments, each imaging device can be configured with an optical axis that is generally parallel with another imaging device, and perpendicular to other imaging devices (e.g., when the steerable mirror is in a neutral position). For example, imaging devices 302 and 304 can be configured to face each other (e.g., such that the imaging devices have substantially parallel optical axes), and the other imaging devices can be configured to have optical axis that are orthogonal to the optical axis of imaging devices 302 and 304.

Note that although the illustrated mounting positions of the imaging devices 302, 304, 306, 308, 310, and 312 relative to one another can be advantageous, in some embodiments, imaging devices for imaging different sides of an object can be reoriented relative the illustrated positions of FIG. 3 (e.g., imaging device can be offset, imaging devices can be placed at the corners, rather than the sides, etc.). Similarly, while there can be advantages (e.g., increased acquisition speed) associated with using six imaging devices that is each configured to acquire imaging data from a respective side of an object (e.g., the six side of object 118), in some embodiments, a different number or arrangement of imaging devices, a different arrangement of mirrors (e.g., using fixed mirrors, using additional moveable mirrors, etc.) can be used to configure a particular imaging device to acquire images of multiple sides of an object. For example, fixed mirrors disposed such that imaging devices 306 and 310 can capture images of a far side of object 318 and can be used in lieu of imaging devices 308 and 312. In some embodiments, system 300 can be configured to image each of the multiple objects 318, 334, 336 on the platform 316.

In some embodiments, system 300 can include a dimensioner 330. As described above with respect to FIGS. 1A, 1B and 2, a dimensioner can be configured to determine dimensions and/or a location of an object supported by support structure 316 (e.g., object 318, 334, or 336). As mentioned above, in some embodiments, dimensioner 330 can determine 3D coordinates of each corner of the object in a coordinate space defined with reference to one or more portions of system 300. For example, dimensioner 330 can determine 3D coordinates of each of eight corners of an object that is at least roughly cuboid in shape within a Cartesian coordinate space defined with an origin at dimensioner 330. As another example, dimensioner 330 can determine 3D coordinates of each of eight corners of an object that is at least roughly cuboid in shape within a Cartesian coordinate space defined with respect to support platform 316 (e.g., with an origin that originates at a center of support platform 316).

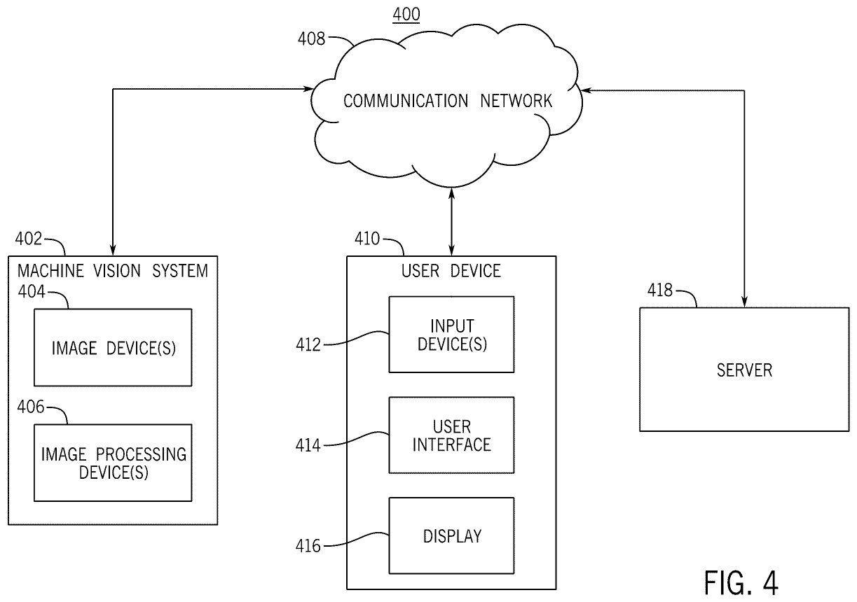

In some embodiments, an image processing device 332 can coordinate operations of imaging devices 302, 304, 306, 308, 310, and/or 312 and/or can perform image processing tasks as described above in connection with image processing device 132 of FIG. 1A and/or image processing device 410 discussed below in connection with FIG. 4.

FIG. 4 shows a system for dynamic testing of a machine vision system in accordance with an embodiment of the technology. In the illustrated example of FIG. 4, system 400 includes a machine vision system 402, a communication network 408, a user device 410, and a server 418. In some embodiments, the system 400 includes fewer, additional, or different components in different configurations than illustrated in FIG. 4. As one example, the system 400 may include multiple machine visions systems 402, multiple user devices 410, multiple servers 418 or a combination thereof. As another example, one or more components of the system 400 may be combined into a single device such as, e.g., user device 410 and server 418.

In some embodiments, the machine vision system 402, the user device 410 and the server 418 can communicate over one or more communication networks 408. In some embodiments, communicating network 408 can be any suitable communication network or combination of communication networks. For example, communication network 408 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 408 can be a local area network (LAN), a wide area network (WAN), a public network (e.g., the Internet), a private or semi-private network (e.g., a corporate or university intranet), any other suitable type of network, or any suitable combination of networks. Communications links shown in FIG. 4 can each be any suitable communications link or combination of communications links, such as wired links, fiber optic links, Wi-Fi links, Bluetooth links, cellular links, etc. In some embodiments, components of system 400 may communicate directly as compared to through communication network 408. In some embodiments, the components of system 400 may communicate through one or more intermediary devices not illustrated in FIG. 4

As shown in FIG. 4, the machine vision system 402 may include one or more imaging devices 404 and one or more image processing devices 406. In some embodiments, the imaging device(s) 404 and imaging processing device(s) 406 may communicate over one or more wired or wireless communication lines or buses, or a combination thereof. In some embodiments, the machine vision system 402 may include fewer, additional, or different components in different configurations than illustrated in FIG. 4. In some embodiments, the machine vision system 402 may include one or more imaging devices 404 in a tunnel arrangement such as, for example, described above with respect to FIGS. 1A, 1B, 2 and 3. In one example, the image processing device 406 (e.g., image processing device 132) can receive images and/or information about each image (e.g., 2D locations associated with the image) from one or more imaging devices 404 (e.g., one or more imaging devices 112a, 112b and 112c described above in connection with FIGS. 1A and 1B, imaging devices in imaging device banks 212, 214, 216, 218, 220, 222 described above in connection with FIG. 2, and/or imaging device 302, 304, 306, 308, 310, 312 described above in connection with FIG. 3). In some embodiments, the machine vision system 402 may also include a dimension sensing system (not shown), for example, dimensioner 150, dimensioner 206, dimensioner 330, described above with respect to FIGS. 1A, 1B, 2 and 3. As discussed above, the dimensioner may be used to provide dimension data about an object imaged by imaging devices 404 to the image processing device 406. In some embodiments, the dimensioner may be locally connected to image processing device 406 and/or connected via a network connection (e.g., via a communication network 408). Image processing device 406 can also receive input from any other suitable devices, such as a motion measurement device (not shown) configured to output a value indicative of movement of a conveyor over a particular period of time which can be used to determine a distance that an object has traveled (e.g., between when dimensions were determined and when each image of the object is generated). Image processing device 406 can also coordinate operation of one or more other devices, such as one or more light sources (not shown) configured to illuminate an object (e.g., a flash, a flood light, etc.). Additionally or alternatively, image processing device 406 can execute a portion of a symbol decoding process to identify and/or decode symbols (e.g., barcodes, QR codes, text, etc.) associated with an object imaged by imaging devices 404 using any suitable technique or combination of techniques.

In some embodiments, imaging device(s) 404 can be any suitable imaging devices. For example, each including at least one imaging sensor (e.g., a CCD image sensor, a CMOS image sensor, or other suitable sensor), at least one lens arrangement, and at least one control device (e.g., a processor device) configured to execute computational operations relative to the imaging sensor. In some embodiments, a lens arrangement can include a fixed-focus lens. Additionally or alternatively, a lens arrangement can include an adjustable focus lens, such as a liquid lens or a known type of mechanically adjusted lens. Additionally, in some embodiments, imaging devices 302 can include a steerable mirror that can be used to adjust a direction of a FOV of the imaging device. In some embodiments, one or more imaging devices 404 can include a light source(s) (e.g., a flash, a high intensity flash, a light source described in U.S. Patent Application Publication No. 2019/0333259, etc.) configured to illuminate an object within a FOV. In some embodiments, imaging device(s) 404 may be similar to, for example, the imaging devices 112, 234, 236, 238, 240, 302, 304, 306, 308, 310, and 312 as discussed above with respect to FIGS. 1A, 1B, 2 and 3.

In some embodiments, imaging device(s) 404 can be local to an image processing device 406. For example, imaging devices 404 can be connected to image processing device 406 by a cable, a direct wireless link, etc. Additionally or alternatively, in some embodiments, imaging devices 404 can be located locally and/or remotely from image processing device 406, and can communicate data (e.g., image data, dimension and/or location data, etc.) to image processing device 406 (and/or server 418) via a communication network (e.g., communication network 408). In some embodiments, one or more imaging devices 404, image processing devices 406, and/or any other suitable components can be integrated as a single device (e.g., within a common housing).

As shown in FIG. 4, user device 410 can include one or more input device(s) 412, a user interface 414, and a display 416. User device 410 may be configured to enable an operator or user to perform dynamic testing of the machine vision system 402, as discussed further below. Input device(s) 412 can be configured to receive data or information from a user or operator. In some embodiments, input device(s) can include any suitable input devices and/or sensors that can be used to receive user input, such as a keyboard, a mouse, a touchscreen, a microphone, etc. User interface 414 may be configured to provide one or more graphical user interfaces (GUIs) that are configured to allow the user to interact with (e.g., provide input to and receive output from) the user device 410. In some embodiments, the GUIs may be displayed to a user on display 416. In some embodiments, display 416 can include any suitable display devices, such as a computer monitor, a touchscreen, a television, etc. In some embodiments, the GUIs may be generated using a processor device (not shown) on user device 410 or may be generated by a separate device such as, for example, server 418 and transmitted to the user device 410 (e.g., over the communication network 408) as discussed further below. The user device 410 may also include other components not illustrated such as, for example, a processor device (e.g., a microprocessor, an application-specific integrated circuit (ASIC), or another suitable electronic device), a memory (e.g., a non-transitory, computer readable medium), a communication system (e.g., a transceiver) for communicating over the communication network 408 and, optionally, one or more additional communication networks or connections.

In some embodiments, image processing device 406, user device 410, and/or server 418 can be any suitable computing device or combination of devices, such as a desktop computer, a laptop computer, a smartphone, a tablet computer, a wearable computer, a server computer, a virtual machine being executed by a physical computing device, etc.

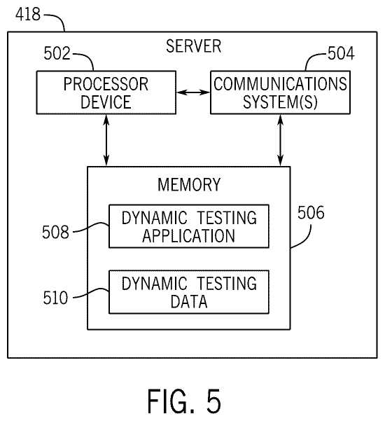

In some embodiments, image processing device 410 can communicate image data (e.g., images received from the imaging device(s) 404) and/or data received from a dimension sensing system (not shown) to a server 418 or user device 410 over communication network 408. In some embodiments, user device 410 can communicate data to and receive data from the server 418, for example, data for dynamic testing of machine vision system 402, over communication network 408. FIG. 5 shows an example of a server 418 in the system shown in FIG. 4 in accordance with an embodiment of the technology. As shown in FIG. 5, server 418 can include a processor device 502, one or more communications systems 504, and/or memory 506. The processor device 502, the communications system 504, and the memory 506 may communicate over one or more wired or wireless communication lines or buses, or a combination thereof. The server 418 may include additional components than those illustrated in FIG. 5 in various configurations. For example, the server 418 may also include one or more inputs such as, for example, a keyboard, a mouse, a touchscreen, a microphone, etc. that receive inputs from the user. In another example server 418 may also include a display such as for example a computer monitor, a touchscreen, a television, etc. The server 418 may also perform additional functionality other than the functionality described here. Also, the functionality described herein as being performed by the server 418 may be distributed among multiple servers or devices (e.g., as part of a cloud service or cloud-computing environment), combined with other components of the system 400 (e.g., combined with the user device 410, one or more components of the machine vision system 402, or the like), or a combination thereof.

In some embodiments, processor device 502 can be any suitable hardware processor or combination of processors, such as a CPU, a GPU, an ASIC, an FPGA, etc. In some embodiments, communications systems 504 can include any suitable hardware, firmware, and/or software for communicating information over communication network 408 (shown in FIG. 4) and/or any other suitable communication networks. For example, communications systems 504 can include one or more transceivers, one or more communication chips and/or chip sets, etc. that communicate with the machine vision system 402, the user device 410, or a combination thereof over the communication network 408. In a more particular example, communications systems 504 can include hardware, firmware and/or software that can be used to establish a Wi-Fi connection, a Bluetooth connection, a cellular connection, an Ethernet connection, etc.

In some embodiments, memory 506 can include any suitable storage device or devices that can be used to store instructions, values, etc., that can be used, for example, by processor device 502 to process data, to generate content (e.g., GUIs), to communicate with one or more user devices 410, to communicate with one or more machine vision systems 402, etc. Memory 506 can include any suitable volatile memory, non-volatile memory, storage, or any suitable combination thereof. For example, memory 506 can include RAM, ROM, EEPROM, one or more flash drives, one or more hard disks, one or more solid state drives, one or more optical drives, etc. In some embodiments, memory 506 can have encoded thereon a server program for controlling operation of server 418. For example, in such embodiments, processor device 502 can receive data from image processing device 406 (e.g., images associated with an object, etc.), image devices 404, and/or user device 410.

As shown in FIG. 5, the memory 506 can include a dynamic testing application 508. The dynamic testing application 508 is a software application executable by the processor device 502 in the example illustrated and as specifically discussed below, although a similarly purposed module can be implemented in other ways in other examples. As described in more detail below, the processor device 502 executes the dynamic testing application 508 to determine if the machine vision system 402, for example, a tunnel system, was built and installed according to the customer's design specifications. Memory 506 also can include dynamic testing data 510. In some embodiments, the dynamic testing data 510 can include data received from a user (e.g., testing parameters), data collected using the tunnel 402 (e.g., encoder (or other motion measurement device) check data, left and right justify test data), and test result summaries and reports generated by, for example, the processor 502 and dynamic testing application 508.

In some embodiments, the functionality described herein as being performed by the server 418 may be locally performed by the user device 410. For example, in some embodiments, the user device 410 may store dynamic testing application 508, the dynamic testing data 510, or a combination thereof. As described in further detail below, a user may use the user device 410 to test a machine vision system 402 (e.g., a tunnel) via, e.g., the dynamic testing application, the dynamic testing data, or a combination thereof.

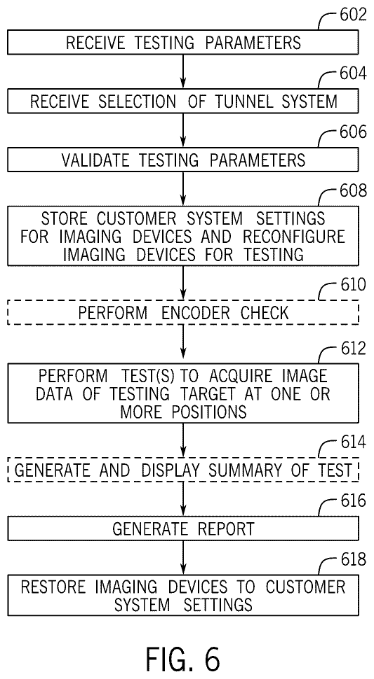

FIG. 6 illustrates a method for dynamic testing of a machine vision system in accordance with an embodiment of the technology. The method illustrated in FIG. 6 is described herein as being performed by the server 418 and, in particular, the dynamic testing application 508 may be executed by the processor device 502. However, as noted above, the functionality described with respect to the method for dynamic testing may be performed by other devices, such as the user device 410, component(s) of the machine vision system 402, or distributed among a plurality of devices, such as a plurality of servers included in a cloud device.

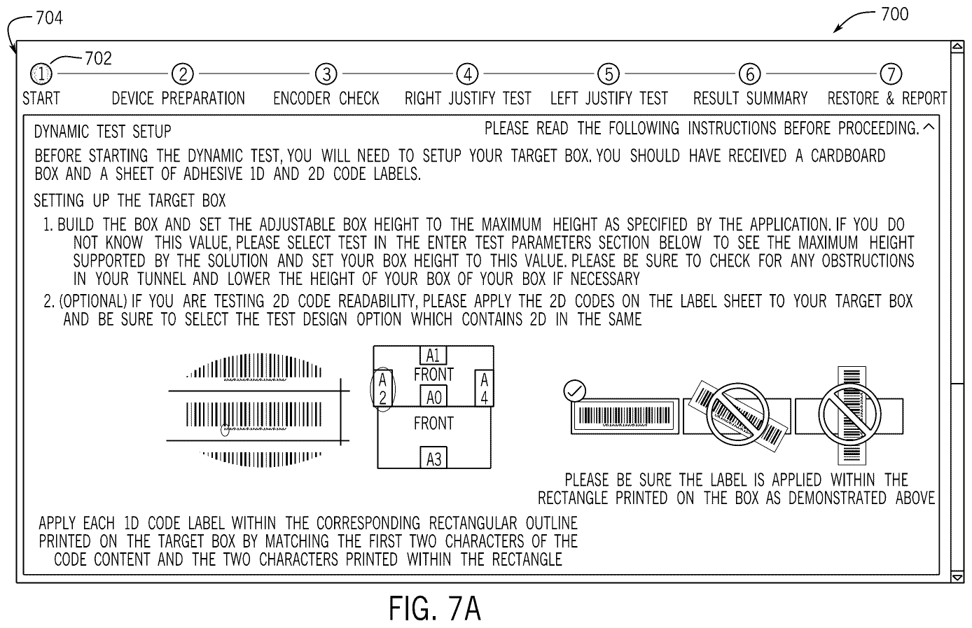

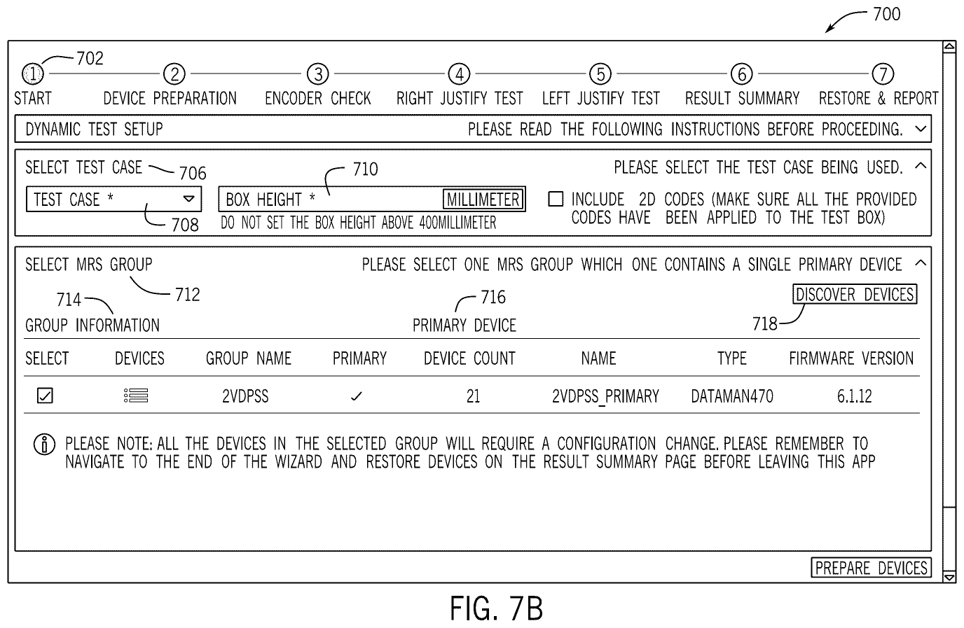

The process illustrated in FIG. 6 is described below with reference to elements of the system 400 for dynamic testing of a machine vision system as illustrated in FIGS. 4 and 5 as well as with reference to FIGS. 7A-13 which are example screenshots of graphical user interfaces (GUIs) for dynamic testing of a machine vision system. Although the blocks of the process are illustrated in a particular order, in some embodiments, one or more blocks may be executed in a different order than illustrated in FIG. 6, or may be bypassed.

At block 602, a set of testing parameters may be received. In some embodiments, the set of testing parameters may be received from a user. In some embodiments, the set of testing parameters may be retrieved from a predetermined specification for a machine vision system or tunnel system 402 being tested that can, for example, specify select parameters of the machine vision system or tunnel. In some embodiments, the predetermined specification may be stored in and retrieved from the memory 506 of the server 418. In some embodiments, the dynamic testing application 508, may be configured to generate a graphical user interface configured to receive inputs from a user. In some embodiments, the server 418 may transmit the generated graphical user interface to the user device 410. FIGS. 7A and 7B illustrate an example setup (or start page) user interface 700 that may be displayed (e.g., as a user interface 414 on display 416 of user device 410) to a user to receive data including, for example, testing parameters for a dynamic test of an installed tunnel system 402. As illustrated in FIG. 7A, the setup user interface 700 can include a header 702 that indicates the steps of the dynamic testing process and identifies (e.g., using a visual indicator) the current step being performed by the system 400. For example, in the user interfaces shown in FIGS. 7A and 7B, the “Start” visual indicator can be highlighted in a color (e.g., yellow). In some embodiments, the setup user interface 700 can include a section 704 that provides a set of instructions for setup of the dynamic test, for example, instructions how to setup (e.g., assemble) a testing target (e.g., a box) that can be run through the tunnel system 402 during the testing process. In some embodiments, the height of the testing target may be adjustably set to a maximum height specified by the application associated with the tunnel system 402 (i.e., the maximum height supported by the specific tunnel system design) and a set of code labels (e.g., 1D and/or 2D codes) may be affixed to the testing target, for example, on five sides of a target box (i.e., all sides (top, front, rear, left, right) except for a bottom side placed on the conveyor of the tunnel system 402 during testing). In some embodiments, the code labels may be affixed to the testing target at predefined locations on the testing target, for example, defined by a rectangle printed on the testing target. In some embodiments, the code on each code label can include information regarding where the code is positioned on the testing target.

The setup user interface 700 can also include sections for receiving testing parameters from a user as shown in FIG. 7B. In some embodiments, the testing parameters can include, for example, test case (or type) information 706 such as a test case identifier 708 and a height 710 of the testing target. In some embodiments, the test case selected by a user may correspond to the size of the code set the user has been provided for use with the testing target. In the example user interface 700 shown in FIG. 7B, a drop down list 708 including available test cases, for example, 10 MIL Nominal and 13 MIL Nominal, may be displayed. A user may select one of the test case options from the drop down list 708. In some embodiments the user may upload information for a custom code set. In addition to selecting the test case, a user may enter the height the user has set the testing target (e.g., a box) to, for example, the height may be entered in an input box 710. In some embodiments, the testing target height 710 may be entered in millimeters or inches. In some embodiments, the setup user interface 700 may also be configured to allow a user to indicate that 2D code labels have been affixed to the testing target and will be included in the test, for example, a user may select a check box 712. It should be understood that in some embodiments, the user interface 700 may be configured to receive other types of testing parameters. In some embodiments, the testing parameters received at block 602 may be stored in the memory 506 of the server 418, for example, as part of the dynamic testing data 510.

In some embodiments, as mentioned above, the testing parameters (e.g., the test case and box height, etc.) may be retrieved from a predetermined specification for the machine vision system or tunnel system being tested that can, for example, specify select parameters of the machine vision system or tunnel. In some embodiments, the predetermined specification may be stored in and retrieved from the memory 506 of the server 418. In some cases, the testing parameters may be automatically provided to the dynamic testing application 508 and, in some cases, automatically populated to the graphical user interface 700.

At block 604, in some embodiments, a selection 714 of the tunnel system 402 (i.e., the multi-reader sync (MRS) group) to be tested may be received from a user. In some embodiments, a list of tunnel systems may be provided for a user to select from using, for example, a check box 722. In some embodiments, the setup user interface 700 may include an input, for example button 720, that may be selected by a user to discover or identify the available tunnel systems which may then be listed for selection. In the example user interface 700, each entry for a tunnel system in the list 714 can include information such as group information 716 and information regarding a primary imaging device 718 in the tunnel system. For example, the group information can include a drop down list to view the imaging devices in the tunnel system (or group), the group name, the number of imaging device in the tunnel system (or group) and the primary device information can include the name of the primary imaging device, a type for the primary imaging device, and the software or firmware) version if the primary imaging device. In some embodiments, the selection of the tunnel system (or group) received at block 604 and data associated with the group may be stored in the memory 506 of the server 418, for example, as part of the dynamic testing data 510. Once the testing parameters have been provided and the tunnel system to be tested are selected, the user may provide an input, for example, select a button (not shown) in the user interface 700 requesting the dynamic testing application 508 proceed to the next step.

In some embodiments, the information regarding the machine vision system or tunnel system 402 (e.g., the multi-reader sync (MRS) group 712) to be tested may be retrieved (e.g., automatically) from a predetermined specification for the machine vision system or tunnel system 402 that can, for example, specify select parameters of the machine vision system or tunnel system 402. In some embodiments, the predetermined specification may be stored in and retrieved from the memory 506 of the server 418. In some cases, the information regarding the machine vision system or tunnel system 402 to be tested (e.g., including information such as MRS group 712, group information 714, primary device 716, etc.) may be automatically provided to the dynamic testing application 508 and, in some cases, automatically populated to the graphical user interface 700.

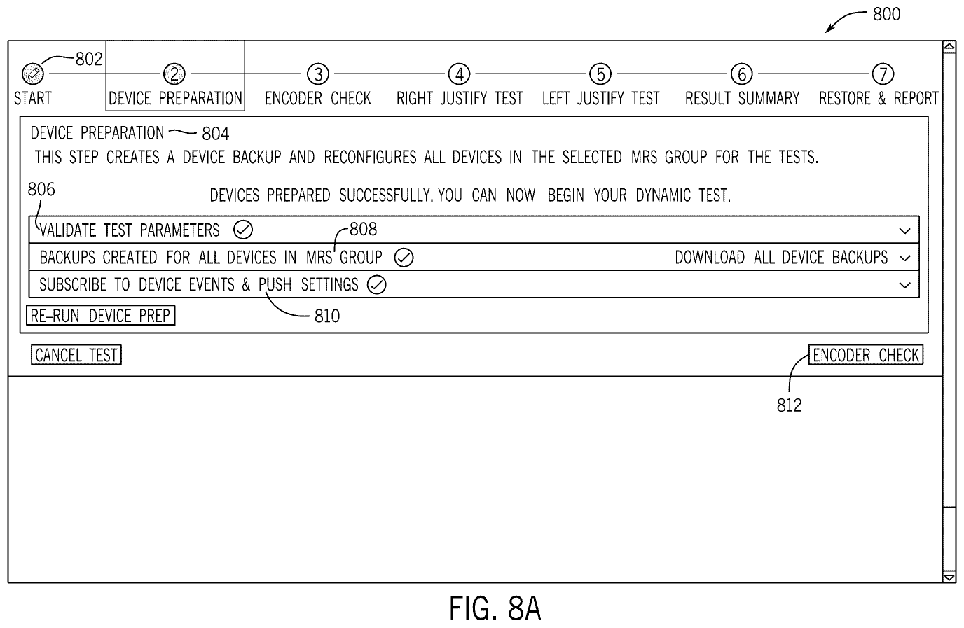

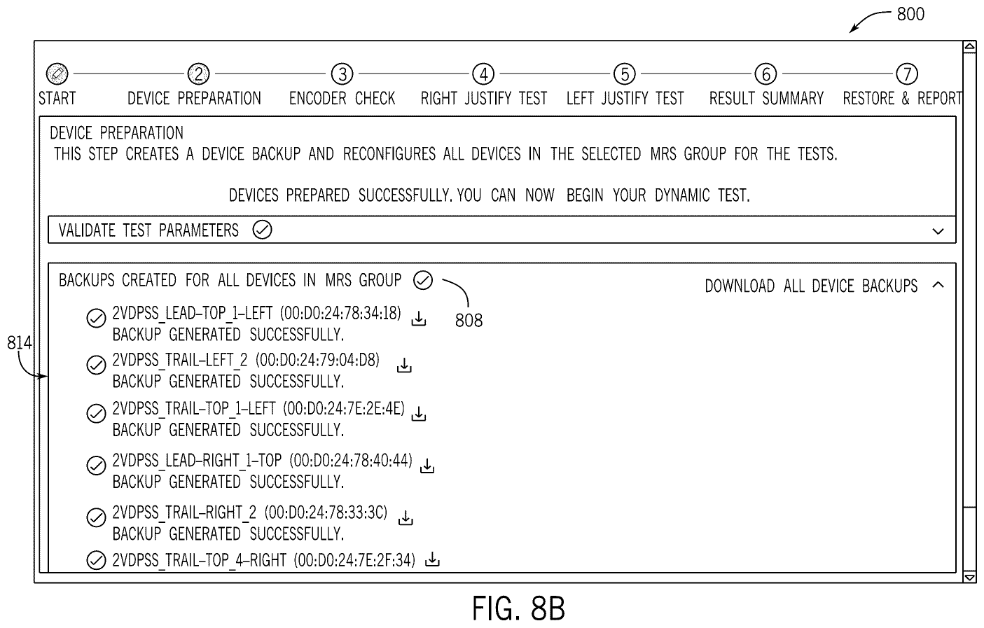

At block 606, the testing parameters can be validated and at block 608, the existing customer system settings for each imaging device 404 in the selected tunnel system 402 (or group) may be automatically stored (e.g., creating a backup), e.g., in the memory 506 of the server 418, for example, as part of the dynamic testing data 510. In some embodiments, at block 608, each of the imaging devices 404 in the selected tunnel system 402 may be automatically reconfigured for testing after the customer system settings have been stored. In some embodiments, the dynamic testing application 508 may be configured to generate a graphical user interface configured to display, for example, the results of validation of the testing parameters and creation of imaging device 404 backups. In some embodiments, the server 418 may transmit the generated graphical user interface to the user device 410. FIGS. 8A and 8B illustrates an example device preparation user interface 700 that may be displayed (e.g., as a user interface 414 on display 416 of user device 410) to a user to allow the user to view, for example, the results of validation of the testing parameters and creation of imaging device backups. As illustrated in FIG. 8A, the validation user interface 800 can include a header 802 that indicates the steps of the dynamic testing process and identifies (e.g., using a visual indicator) the current step being performed by the system 400. For example, in in the user interface 800, the “Device Preparation” visual indicator can be highlighted in a color (e.g., yellow) and the “Start” visual indicator include an edit icon to indicate that the “Start” setup step was completed but may also be edited if needed. The device preparation user interface 800 can also include a section 804 for displaying the results of the validation and device preparation including, for example, whether a particular item has been successful or unsuccessful. For example, in FIG. 8A a check mark may be used to indicate that a particular item was successful. In some embodiments, the check mark may be displayed in a color such as, for example, green. In some embodiments, an unsuccessful validation may be indicated using, for example, a check mark (not shown). In some embodiments, the check mark may be displayed in a color such as, for example, red. In the example shown in FIG. 8A, the user interface 800 provides an indication of whether the validation 806 of the test parameters was successful, whether the customer system settings for each imaging device have been stored (i.e. whether creation of backups 808 for each imaging device was successful), and whether a subscription 810 to device events and push settings was successful. In the example shown in FIG. 8B, in some embodiments, the device preparation user interface 800 may also include a drop down list 814 that allows a user to view a list of all the imaging devices and whether a backup for each imaging device was successfully created. In some embodiments, the device preparation results from blocks 606 and 608 may be stored in the memory 506 of the server 418, for example, as part of the dynamic testing data 510. Once the device preparation has been completed and is successful, the user may provide an input, for example, select a button 812 (shown in FIG. 8A) in the user interface 800 requesting the dynamic testing application 508 proceed to the next step.

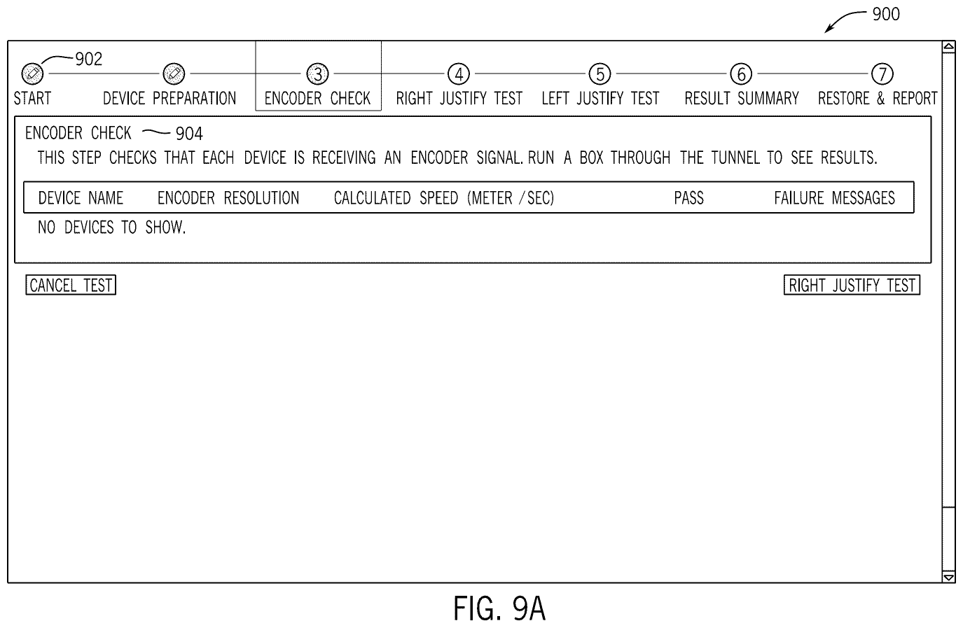

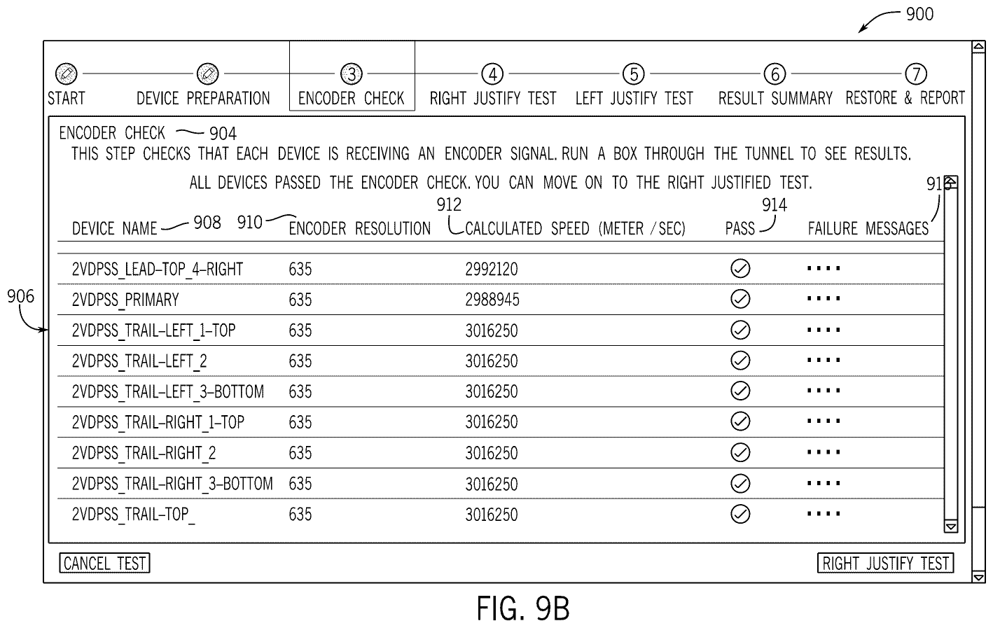

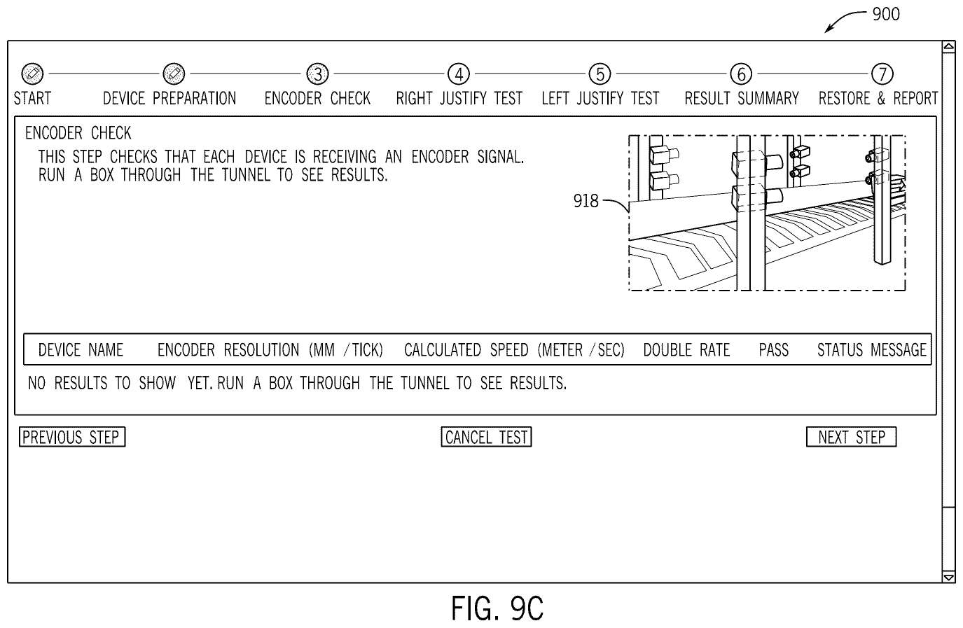

At block 610, an optional encoder check may be performed using the tunnel system 402 (including an encoder), the testing target (e.g., a box), and the dynamic testing application 508. In some cases, if an encoder check is not performed, the process may proceed to block 612 to perform one or more tests using a testing target such as, for example, a right justify test as discussed below. While the following description refers to an encoder check it should be understood that in some embodiments other motion measurement devices may be used in the machine vision system. In some embodiments where an encoder check is performed, a testing target (e.g., a box) may be run through the tunnel system 402 (e.g., by a user) to obtain images from the imaging device(s) and encoder data (e.g., a speed and position) from an encoder (e.g., encoder 152 shown in FIG. 1B). In some embodiments, the encoder check is configured to determine whether each imaging device 404 in the tunnel system 402 detects or observes the same speed and motion of the testing target. In some embodiments, the encoder check at block 610 may be configured to provide a “pass” or “fail” result regarding whether each imaging device 404 in the tunnel system 402 is receiving an encoder signal. In some embodiments, the dynamic testing application 508 may be configured to generate a graphical user interface configured to allow a user to view the results of the encoder check. In some embodiments, the server 418 may transmit the generated graphical user interface to the user device 410. FIGS. 9A-9C illustrate an example encoder check user interface 900 that may be displayed (e.g., as a user interface 414 on display 416 of user device 410) to a user to allow the user to view the results of the encoder check. As illustrated in FIG. 9A, the encoder check user interface 900 can include a header 902 that indicates the steps of the dynamic testing process and identifies (e.g., using a visual indicator) the current step being performed by the system 400. For example, in in the user interface 900, the “Encoder Check” visual indicator can be highlighted in a color (e.g., yellow) and the “Start” visual indicator and “Device Preparation” visual indicator include an edit icon to indicate that these steps have been completed but may also be edited if needed.

The encoder check user interface 900 can also include a section 904 to display the results of the encoder check for each imaging device 404 in the tunnel system 402. As shown in FIG. 9B, in some embodiments, the encoder check user interface 900 may provide a list 906 of the encoder check results for each imaging device 404 in the tunnel system 402. Each entry for an imaging device can include information such as, for example, a name 908 of the imaging device, an encoder resolution 910, calculated speed (e.g., meters/sec) 912, whether the imaging device passed 914 the encoder check, and messages 916 if the imaging device failed the encoder check. In some embodiments, the encoder check user interface 900 may include an example image 918 of a target object (e.g., a box) going through a tunnel. In some embodiments, the encoder check results for each imaging device 404 in the tunnel system 402 from block 610 may be stored in the memory 506 of the server 418, for example, as part of the dynamic testing data 510. Once the encoder has been completed, the user may provide an input, for example, select a button (not shown) in the user interface 800 requesting the dynamic testing application 508 proceed to the next step.

At block 612, one or more test(s) may be performed using the tunnel system 402, the testing target (e.g., a box), and the dynamic testing application 508. For example, in some embodiments, the testing target may be positioned on a conveyor of the tunnel system 402 (e.g., by a user) at a particular position and then run through the tunnel system 402 to obtain images from the imaging device(s) 404 in the tunnel system 402. In some examples, a test may be performed with the testing target positioned so that it aligns with a right side of the conveyor, the testing target positioned so that it aligns with a left side of the conveyor, the testing target positioned so that it aligns with the center of the conveyor, or the testing target positioned at other locations on the conveyor. In some embodiments, a test may be performed for one or more of the possible positions of the testing target. For example, in some embodiments, a test may be performed with the testing target aligned with a right side of the conveyor (e.g., a right justify test) and a test may be performed with the testing target aligned with a left side of the conveyor (e.g., a left justify test). While the following discussion describes a right justify test and a left justify test, it should be understood that different numbers of tests and tests with different positions of the testing target may be performed.

As mentioned above, in one example, a right justify test may be performed. The right justify test may be configured to determine whether each imaging device 404 reads and decodes the code or codes (e.g., a barcode) on the testing target it is expected to read and decode. In some embodiments, as described above with respect to FIGS. 1A, 1B and 2, a tunnel system 402 may include a plurality of banks where each bank consists of one or more imaging devices 404. In some embodiments, the right justify test may be configured to determine whether each bank reads and decodes the code or codes (e.g., a barcode) on the testing target it is expected to read and decode, and whether individual imaging devices 404 in the bank contributed to the decoding result. In some embodiments, the right justify test at block 610 may be configured to provide an overall “pass” or “fail” result that indicates whether all codes on the testing target are read by at least one imaging device 404, and in some embodiments, at least one imaging device 404 in the specified banks of the tunnel system 402, when the testing target is right justified on the conveyor.

In some embodiments, the overall “pass” or “fail” result of the right justify test may be based on individual camera decode results, a bank result, a symbol (e.g., barcode) result, a trigger result, and a sequence result from the right justify test. For example, an individual camera decode result may be defined as an individual decode result from an imaging device 404 during a trigger. Each imaging device may report multiple decode results during a single trigger. In some embodiments, an individual camera decode result that does not match any target symbols on the testing target may be ignored. In some embodiments, a bank result may be determined by comparing collected decode results against the target symbol on the testing target for the enclosing symbol result. In some embodiments, a bank result may be N/A if the bank is not expected to read the target symbol. In some embodiments, a bank result may be “PASS” if any decode result in the bank matches the target symbol and the bank is expected to read the target barcode, and the bank result may be “FAIL” if the bank is expected to read the target symbol but no result in the bank matches the target symbol. In some embodiments, a symbol result may be composed of multiple bank results for a specific physical code on the testing target and a symbol result may be “PASS” if no bank results are FAIL. In some embodiments, a trigger result may be composed of multiple symbol results and a trigger result may be “PASS” if all symbol results are PASS. In some embodiments, a sequence result may be composed of one or more trigger results for a single justification (i.e., a sequence may be the aggregation of one or more triggers) and a sequence result may be considered “PASS” if any individual trigger result is PASS. A user may execute multiple triggers during a sequence for enhanced confidence in tunnel performance, but, in some embodiments, this does not need to be used to impact the logic for the sequence result.

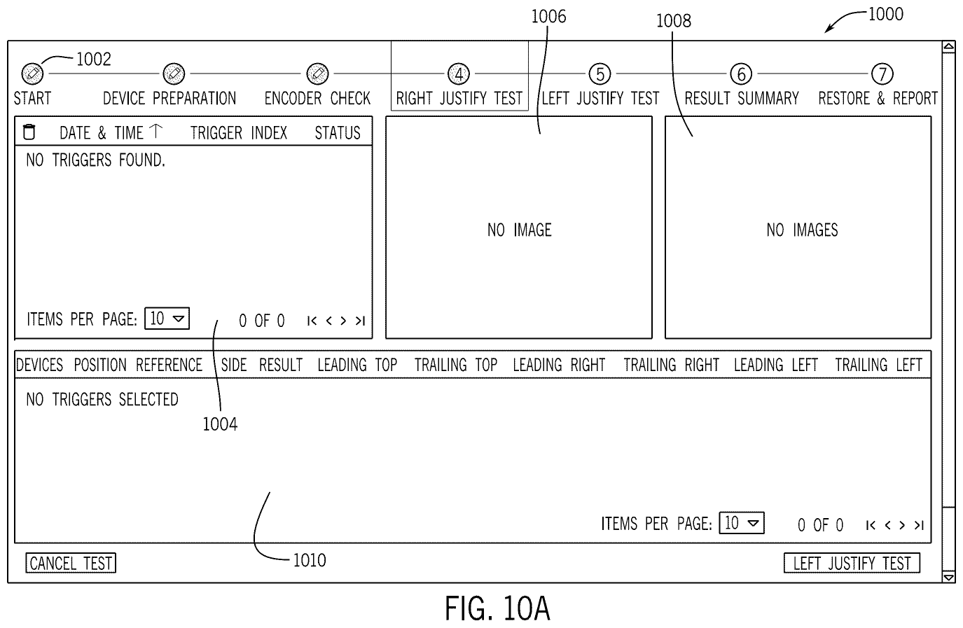

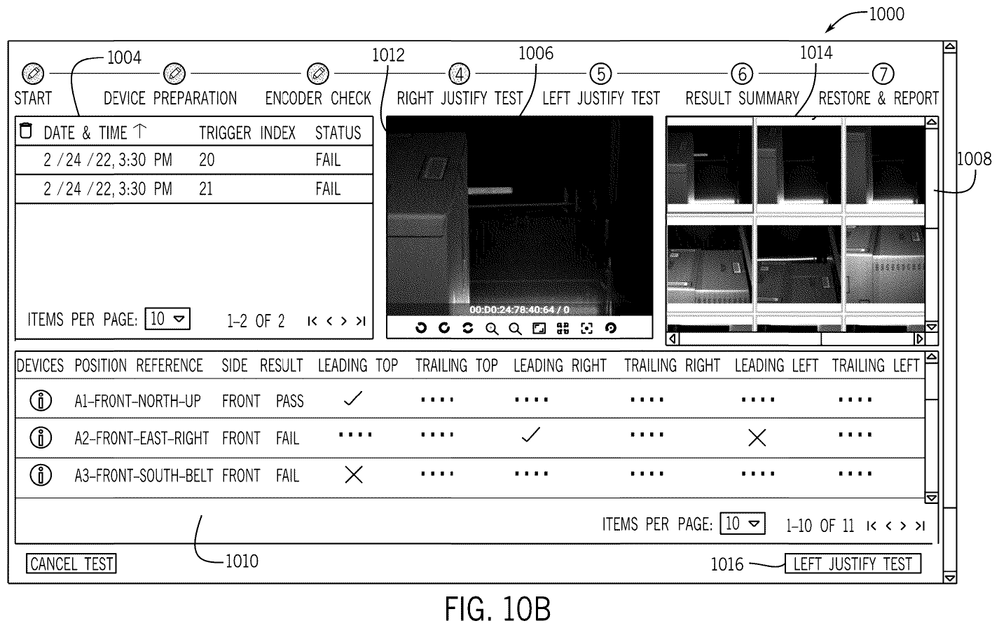

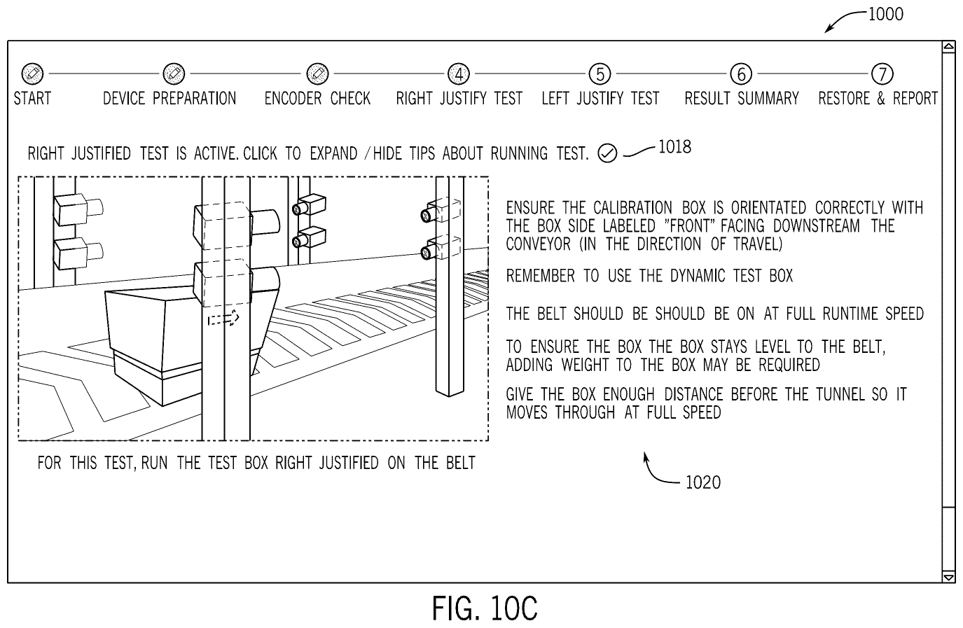

In some embodiments, the dynamic testing application 508 may be configured to generate a graphical user interface configured to allow a user to view the results of the right justify test. In some embodiments, the server 418 may transmit the generated graphical user interface to the user device 410. FIGS. 10A-10C illustrate an example right justify test user interface 1000 that may be displayed (e.g., as a user interface 414 on display 416 of user device 410) to a user to allow the user to view the results of the right justify test. As illustrated in FIG. 10A, the right justify test user interface 1000 can include a header 1002 that indicates the steps of the dynamic testing process and identifies (e.g., using a visual indicator) the current step being performed by the system 400. For example, in the user interface 1000, the “Right Justify Test” visual indicator can be highlighted in a color (e.g., yellow) and the “Start” visual indicator, “Device Preparation” visual indicator, and “Encoder Check” visual indicator include and edit icon to indicate that these steps have been completed but may also be edited if needed. In some embodiments, the right justify test user interface 1000 can include a section 1004 to list triggers executed by the user, sections 1006 and 1008 to display images acquired during a selected trigger, and a code details section 1010 to list the decode results for the selected trigger. In the example, shown in FIG. 10B, in some embodiments, section 1004 includes a list or table of collected triggers and can include information such as date and time, trigger index, and status (i.e., “pass” or “fail”). Sections 1006 and 1008 are shown with example images 1012 and 1014, respectively associated with a trigger selected from the list 1004. For example, a user can select a trigger from list 1004 by using an input device (e.g., input device 412) to “click” on the row for a particular trigger. In the example shown in FIG. 10B, in some embodiments, the code details table 1010 can show for each code on the testing target whether the code failed to read or if it was read, which banks or imaging device read the code and can expose the minimum PPM. In some embodiments, the code details table 1010 can describe to the user why the trigger failed by indicating which criteria were not met, for example, a failure may be caused if a code on the testing target was read by at least one imaging device in the right trailing bank but not by any imaging devices in the right leading bank. In some embodiments, the data from the right justify test collected at block 610 may be stored in the memory 506 of the server 418, for example, as part of the dynamic testing data 510 In some embodiments, once the right justify test is completed, the user may provide an input, for example, select a button (e.g., button 1016 shown in FIG. 10B) in the user interface 1000 requesting the dynamic testing application 508 proceed to the next step. In some embodiments, the right justify test user interface 1000 can include a link 1018 that allows a user to view an explanation (or tips) 1020 on how to run the right justify test as shown in FIG. 10C. For example, as shown in FIG. 10C, explanation (or tips) 1020 may include an animation and text.

As mentioned above, in one example, a left justify test may also be performed using the tunnel system 402, the testing target (e.g., a box), and the dynamic testing application 508. For example, in some embodiments, the testing target may be positioned on a conveyor of the tunnel system 402 (e.g., by a user) so that it aligns with a left side of the conveyor and then run through the tunnel system 402 to obtain images from the imaging device(s) 404 in the tunnel system 402. The left justify test may be configured to determine whether each imaging device 404 reads and decodes the code or codes (e.g., a barcode) on the testing target it is expected to read and decode. In some embodiments, as described above with respect to FIGS. 1A, 1B and 2, a tunnel system 402 may include a plurality of banks where each bank consists of one or more imaging devices 404. In some embodiments, the left justify test may be configured to determine whether each bank reads and decodes the symbol or symbols (e.g., a barcode) on the testing target it is expected to read and decode, and whether individual imaging devices 404 in the bank contributed to the decoding result. In some embodiments, the left justify test at block 610 may be configured to provide an overall “pass” or “fail” result that indicates whether all codes on the testing target are read by at least one imaging device 404, and in some embodiments, at least one imaging device 404 in the specified banks of the tunnel system 402, when the testing target is left justified on the conveyor. As described above with respect to the right justify test, in some embodiments, the overall “pass” or “fail” result of the left justify test may be based on individual camera decode results, a bank result, a symbol (e.g., a barcode) result, a trigger result, and a sequence result from the left justify test.

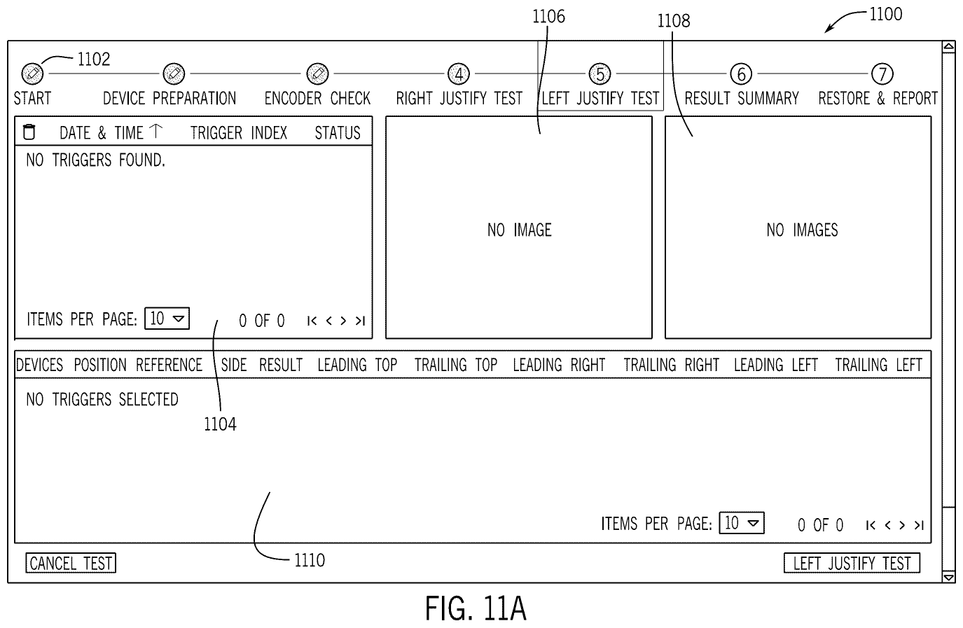

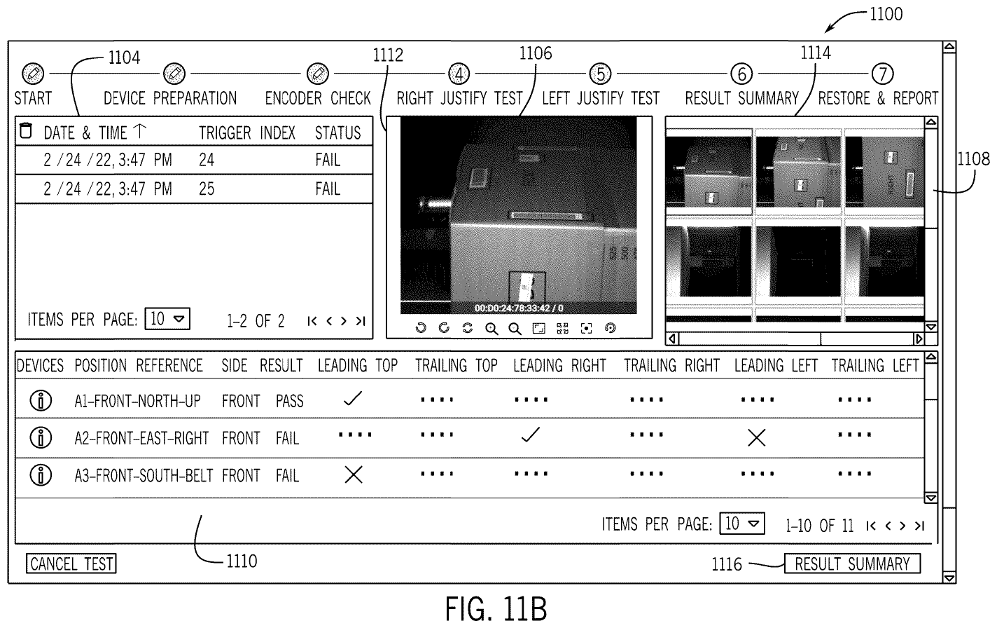

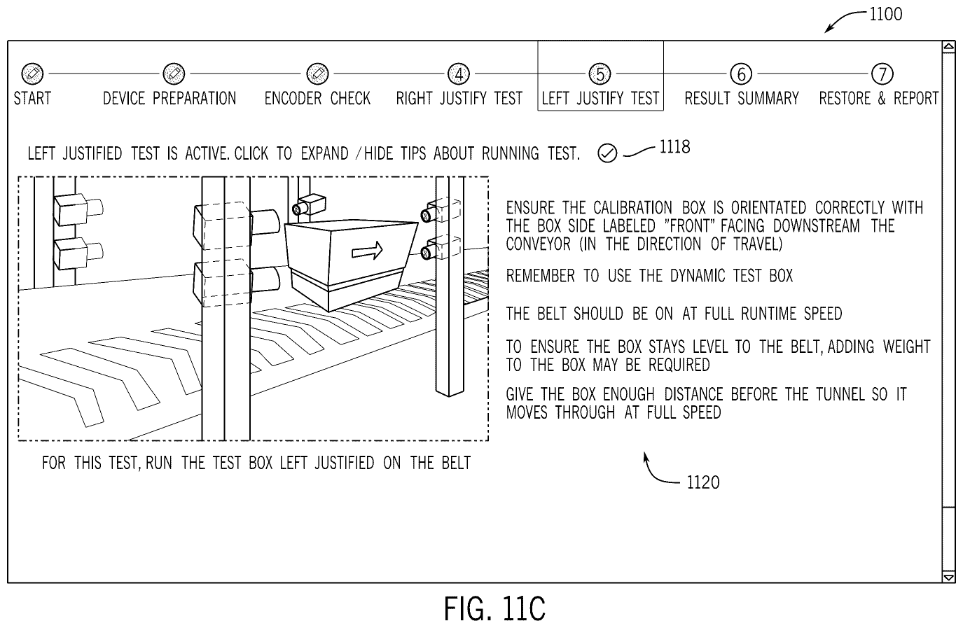

In some embodiments, the dynamic testing application 508 may be configured to generate a graphical user interface configured to allow a user to view the results of the left justify test. In some embodiments, the server 418 may transmit the generated graphical user interface to the user device 410. FIGS. 11A-11C illustrate an example left justify test user interface 1100 that may be displayed (e.g., as a user interface 414 on display 416 of user device 410) to a user to allow the user to view the results of the left justify test. As illustrated in FIG. 11A, the left justify test user interface 1100 can include a header 1102 that indicates the steps of the dynamic testing process and identifies (e.g., using a visual indicator) the current step being performed by the system 400. For example, in in the user interface 1100, the “Left Justify Test” visual indicator can be highlighted in a color (e.g., yellow) and the “Start” visual indicator, “Device Preparation” visual indicator, “Encoder Check” visual indicator, and “Right Justify Test” visual indicator include an edit icon to indicate that these steps have been completed but may also be edited if needed. In some embodiments, the left justify test user interface 1100 can include a section 1104 to list triggers executed by the user, sections 1106 and 1108 to display images acquired during a selected trigger, and a code details section 1110 to list the decode results for the selected trigger. In the example, shown in FIG. 11B, in some embodiments, section 1004 includes a list or table of collected triggers and can include information such as date and time, trigger index, and status (i.e., “pass” or “fail”). Sections 1106 and 1108 are shown with example images 1112 and 1114, respectively associated with a trigger selected from the list 1104. For example, a user can select a trigger from list 1104 by using an input device (e.g., input device 412) to “click” on the row for a particular trigger. In the example shown in FIG. 11B, in some embodiments, the code details table 1110 can show for each code on the testing target whether the code failed to read or if it was read, which banks read the code and can expose the minimum PPM. In some embodiments, the code details table 1110 can describe to the user why the trigger failed by indicating which criteria were not met, for example, a failure may be caused if a code on the testing target was read by at least one imaging device in the left trailing bank but not by any imaging devices in the left leading bank. In some embodiments, the data from the left justify test collected at block 610 may be stored in the memory 506 of the server 418, for example, as part of the dynamic testing data 510. In some embodiments, once the left justify test is completed, the user may provide an input, for example, select a button (e.g., button 1116 shown in FIG. 11B) in the user interface 1100 requesting the dynamic testing application 508 proceed to the next step. In some embodiments, the left justify test user interface 1100 can include a link 1118 that allows a user to view an explanation (or tips) 1120 on how to run the left justify test as shown in FIG. 11C. For example, as shown in FIG. 11C, the explanation (or tips) 1120 may include an animation and text.

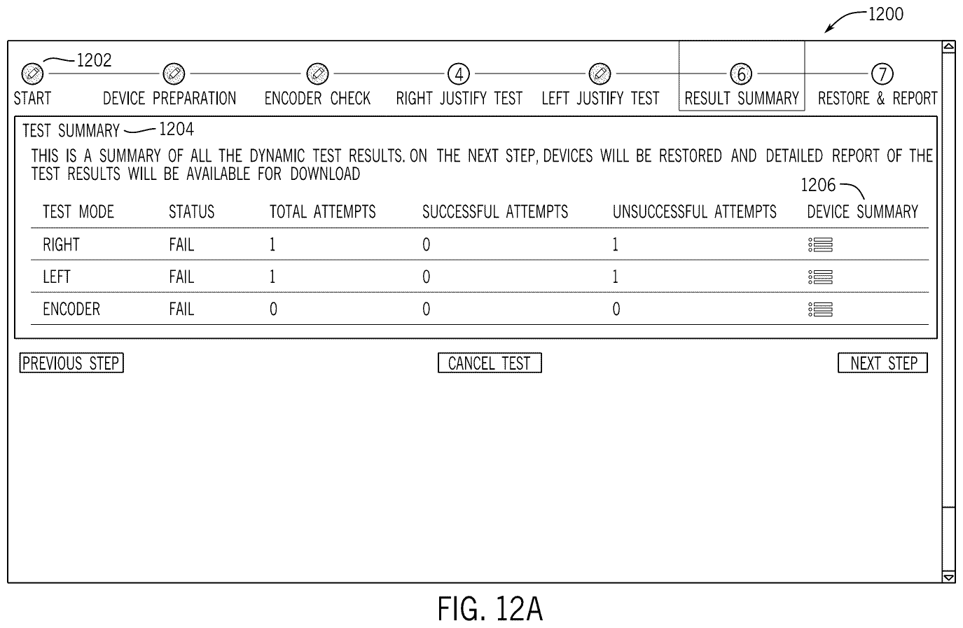

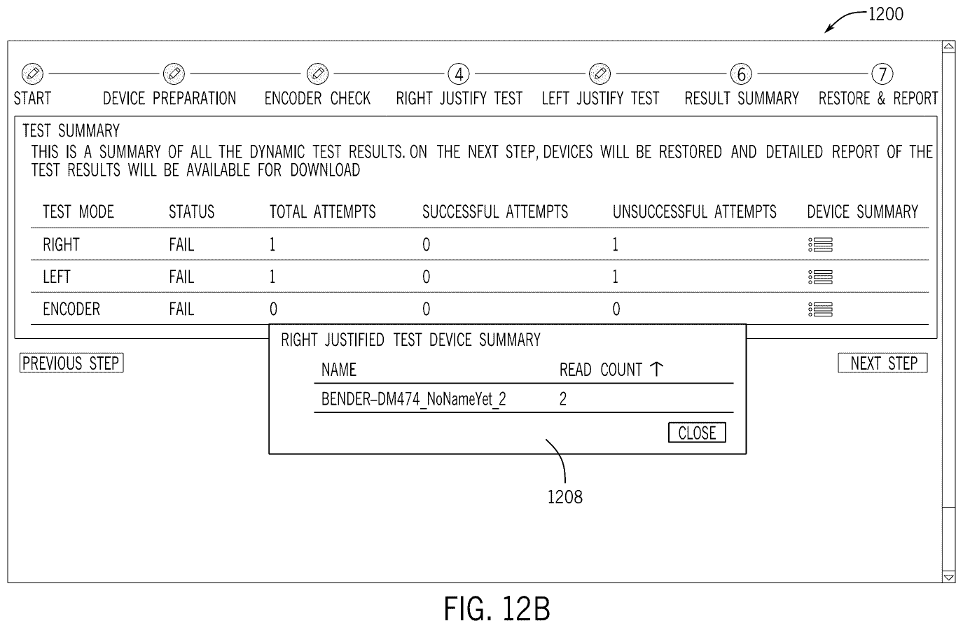

In some embodiments, a summary of the encoder check (if applicable), the right justify test and the left justify test may be optionally generated and displayed at block 614. In some cases, if a summary is not provided, the process may proceed to block 616 to generate a report as discussed below. In some embodiments, where a summary is provided, the dynamic testing application 508 may be configured to generate a graphical user interface configured to allow a user to view an optional summary of the test(s), for example, right and left justify tests. In some embodiments, the server 418 may transmit the generated graphical user interface to the user device 410. FIGS. 12A and 12B illustrates an example results summary user interface 1200 that may be displayed (e.g., as a user interface 414 on display 416 of user device 410) to a user to allow the user to view the results of, for example, the encoder check, and the right and left justify tests. As illustrated in FIG. 12A, the results summary user interface 1200 can include a header 1202 that indicates the steps of the dynamic testing process and identifies (e.g., using a visual indicator) the current step being performed by the system 400. For example, in in the user interface 1200, the “Result Summary” visual indicator can be highlighted in a color (e.g., yellow) and the “Start” visual indicator, “Device Preparation” visual indicator, “Encoder Check” visual indicator, “Right Justify Test” visual indicator, and “Left Justify Test” visual Indicator include an edit to indicate that these steps have been completed but may be edited if needed. In some embodiments, the results summary user interface 1200 may include a test summary section 1204 that provides a table summarizing the encoder check, and the test results, for example, the left justify test results and the right justify test results. In addition, the test summary section 1204 may also include a device summary column 1206 with icons that may be selected to view a dialog box 1208 (shown in FIG. 12B) with device summary information for a selected test (e.g., either the left or right justify test). For example, a listing of all of the imaging devices and the symbols that were decoded for that specific test (or run). In some embodiments, the summary of the encoder check and the left and right justify test results generated at block 616 may be stored in the memory 506 of the server 418, for example, as part of the dynamic testing data 510.

In some embodiments, once a user has reviewed the summary of the encoder check, the test(s), for example, a left justify test and a right justify test, the user may provide an input, for example, select a button (not shown) in the user interface 1200 requesting the dynamic testing application 508 proceed to complete the dynamic testing process. In some embodiments, completion of the dynamic testing process can include automatically generating a report at block 616 and automatically restoring each of the imaging devices 404 in the tunnel system to their customer system settings at block 618. In some embodiments, a confirmation that the imaging devices 414 have been restored may be provided to the user, for example, on a display 416 of a user device 410. In some embodiments, the dynamic testing application 508 may be configured to generate a graphical user interface configured to allow a user to download the report generated at block 616. In some embodiments, the downloaded report may be used by a customer to sign off on the installed tunnel device. In some embodiments, the overall results of the dynamic testing of the installed tunnel system may be determined by combining the results from each performed test “sequences” (e.g., both the left- and right-justify test “sequences”), where, as described above, a “sequence” is an aggregation of one or more triggers. In some embodiments, the overall result may be “PASS” if each test (e.g., both the left and right justification tests) is “PASS” and all imaging devices are shown to have received the encoder signal. In some embodiments, the results of the dynamic testing can also report if one or more individual imaging devices were unable to provide a symbol result during the tests (e.g., the left- and right-justify tests). In some embodiments, the individual camera results may not be a pass/fail criterion as there may be tunnel design where it is impractical to obtain reads from all individual imaging devices without more exhaustive test sequences (i.e., beyond just left- and right-justified).

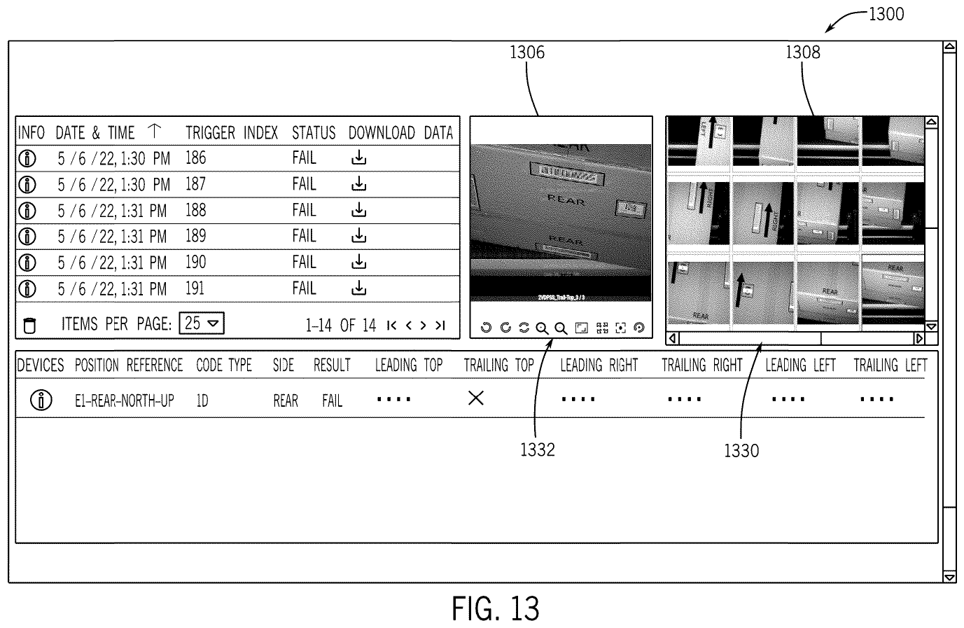

FIG. 13 illustrates an example justify test user interface in accordance with an embodiment of the technology. As discussed above with respect to FIGS. 10B and 11B, the right 1000 and left 1100 justify test user interfaces can include sections 1006, 1106 and 1008, 1108 to display images acquired during a selected trigger. In some embodiments, a justify test user interface 1300 (e.g., a right justify test, left justify test, center justify test, etc.) may be configured to allow a user to select an image from the set of images (e.g. a thumbnail grouping) in section 1308 and view an SVG overlay on the selected image in section 1306 that may indicate whether a symbol was successfully read on the selected image.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIG. 6 can be executed or performed in any order or sequence not limited to the order and sequence shown and described in the figures. Also, some of the above steps of the processes of FIG. 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for dynamic testing of a machine vision system, the machine vision system including a tunnel system having a conveyor and at least one imaging device, the method comprising:
receiving a set of testing parameters and a selection of a tunnel system;
validating the testing parameters;
controlling the at least one imaging device to acquire a set of image data of a testing target positioned at a predetermined justification on the conveyor, wherein the testing target includes a plurality of target symbols;
determining a test result by analyzing the set of image data to determine if the at least one imaging device reads a target symbol associated with the at least one imaging device; and
generating a report including the test result.

2. The method according to claim 1, further comprising displaying the test result using a display.

3. The method according to claim 1, wherein the set of image data of the testing target includes image data of the testing target positioned at the predetermined justification corresponding to a right side of the conveyor.

4. The method according to claim 1, wherein the set of image data of the testing target includes image data of the testing target positioned at the predetermined justification corresponding to a left side of the conveyor.

5. The method according to claim 1, wherein the testing parameters include one or more of a height of the testing target or a test type indicating a size of the plurality of target symbols of the testing target.

6. The method according to claim 5, wherein the height of the testing target is a pre-specified maximum height supported by the tunnel system.

7. The method according to claim 1, further comprising before acquiring the set of image data, storing a set of existing customer system settings for the at least one imaging device.

8. The method according to claim 7, further comprising after storing the set of existing customer system settings for the at least one imaging device, reconfiguring the at least one imaging device based on the testing parameters.

9. The method according to claim 8, further comprising, after determining the test result, restoring the at least one imaging device to the set of existing customer system settings.

10. The method according to claim 1, wherein the at least one imaging device comprises a plurality of imaging devices.

11. The method according to claim 10, wherein the plurality of imaging devices are divided into a plurality of banks.

12. The method according to claim 11, wherein determining a test result further comprises analyzing the set of image data to determine if at least one imaging device in the bank reads a target symbol associated with the bank.

13. The method according to claim 1, wherein the at least one imaging device comprises one imaging device.

14. The method according to claim 1, further comprising determining if the at least one imaging device correctly received motion data based on the set of image data.

15. A system for dynamic testing of a machine vision system, the machine vision system including a tunnel system having a conveyor and at least one imaging device, the system for dynamic testing comprising:
an input for receiving a set of testing parameters and a selection of a tunnel system;
at least one processor device coupled to the input, the at least one processor device configured to:
validate the testing parameters;
control the at least one imaging device to acquire a set of image data of a testing target positioned at a predetermined justification on the conveyor, wherein the testing target includes a plurality of target symbols;
determine a test result by analyzing the set of image data to determine if the at least one imaging device reads a target symbol associated with the at least one imaging device; and
generate a report including the test result.

16. The system according to claim 15, further comprising a display coupled to the at least one processor device and configured to display the test result.

17. The system according to claim 15, wherein the set of image data of the testing target includes image data of the testing target positioned at the predetermined justification corresponding to a right side of the conveyor.

18. The system according to claim 15, wherein the set of image data of the testing target includes image data of the testing target positioned at the predetermined justification corresponding to a left side of the conveyor.

19. The system according to claim 15, wherein the at least one imaging device comprises a plurality of imaging devices.

20. The system according to claim 19, wherein the plurality of imaging devices are divided into a plurality of banks.

21. The system according to claim 20, wherein determining a test result further comprises analyzing the set of image data to determine if at least one imaging device in the bank reads a target symbol associated with the bank.

22. The system according to claim 15, wherein the at least one imaging device comprises one imaging device.

23. The system according to claim 15, wherein the at least one processor device is further configured to determine if the at least one imaging device correctly received motion data based on the set of image data.
